(19) United States
(12) Patent Application Publication
(10) Pub. No.: US 2026/0203814 A1
(43) Pub. Date: Jul. 16, 2026

(54) SYSTEMS AND METHODS FOR MANAGING DEBT PORTFOLIOS AND OBLIGATION PORTFOLIOS

(71) Applicant: NEW DEFINITION MEDIA INC., Montreal (CA)

(72) Inventors: Felicia HENRY-PARDIAK, Montreal (CA); Edward PARDIAK, Montreal (CA)

(21) Appl. No.: 19/135,667

(22) PCT Filed: Dec. 4, 2023
(86) PCT No.: PCT/IB2023/062213

§ 371 Date: Jun. 4, 2025

Related U.S. Application Data
(60) Provisional application No. 63/430,165, filed on Dec. 5, 2022.

(51) Int. Cl. G06Q 40/03

(52) U.S. Cl. CPC G06Q 40/039; G06Q 2220/00

(57) ABSTRACT

There is disclosed a method and system for transferring a debt portfolio or, alternatively, transferring an obligation portfolio. A smart contract corresponding to the debt or obligation portfolio is generated. The smart contract generates a virtual network layer. The smart contract is stored on a virtual, or distributed, ledger. A first bot is activated to determine whether the debt or obligation portfolio and an owner of the debt or obligation portfolio are compliant with regulations. A second bot is activated to determine a predicted valuation of the debt or obligation portfolio. If the debt or obligation portfolio is compliant with regulations, and the predicted valuation of the debt or obligation portfolio meets the terms of the smart contract, the smart contract is executed.

### CROSS-REFERENCE

The present application claims priority from U.S. Provisional Patent Application No. 63/430,165, filed on Dec. 5, 2022, the disclosure of which is incorporated by reference herein in its entirety.

### TECHNICAL FIELD

The present technology relates to contract management. In particular, the present technology introduces systems and methods for managing debt portfolios and obligation portfolios.

### BACKGROUND

Various conventional systems and cloud-based platforms servicing the debt recovery sector have their origins in accounting software systems that have been modified to accommodate debt recovery operations.

In order to differentiate in this market space, some of these accounting software systems have expanded to incorporate voice over internet protocol (VoIP) auto-dialers, rudimentary auto-resolve web-based debt resolution and payments, skip tracing, compliance, or the like. The conventional systems and services are standalone, poorly integrated solutions with simplistic machine learning algorithm (MLA) and artificial intelligence (AI) functions targeting individual debt recovery agencies. None of the conventional systems and services are designed to network with counterparties in the debt industry nor offer any true transparency features that range from due diligence, portfolio performance analytics, and valuation of debt portfolios, to the execution of remittances in real time.

With debt recovery comes federal and state compliance obligations, especially around what regulators require of debt recovery organizations. This is the point where a lot of debt recovery agencies experience difficulty with the conventional systems and services. Conventional systems and services do not provide adequate services for managing regulatory obligations, and fail to serve the best interests of debt recovery agencies and/or debtors.

With this said, there is an interest in developing efficient systems and methods for managing debt portfolios.

### SUMMARY

Various implementations of the present disclosure provide a computer-based system, such as, for example, but without being limitative, an electronic device comprising at least one processor and a memory storing program instructions for executing one or more methods described herein, the program instructions being executable by at least one processor of the electronic device.

In a first aspect, various implementations of the present technology provide a method comprising:
generating a first smart contract corresponding to a debt portfolio comprising a plurality of debts, the first smart contract generating a virtual network layer and a virtual ledger;
storing the first smart contract in the virtual ledger on the virtual network layer;
activating, based on self-executing functions of the first smart contract, a first bot to determine whether each debt in the debt portfolio and an owner of the debt portfolio are compliant with regulations corresponding to the respective debt;
activating, based on the self-executing functions of the first smart contract, a second bot to determine a predicted valuation for the debt portfolio; and
after confirming, by the first bot, that the debt portfolio is compliant with the regulations, and confirming, by the second bot, that the predicted valuation is sufficient for the first smart contract, executing the first smart contract.

In some implementations of the present technology, executing the first smart contract causes ownership of the debt portfolio to be transferred from the owner to one or more purchasers, and causes payment to be transferred to the owner.

In some implementations of the present technology, the method further comprises sending a notice of transfer of ownership for each debt of the plurality of debts based on self-executing regulatory and compliance functions of the first smart contract.

In some implementations of the present technology, the method further comprises: generating a second smart contract corresponding to financing a purchase of the debt portfolio, the second smart contract generating a new virtual network layer and a new virtual ledger; storing the second smart contract in the new virtual ledger; executing the second smart contract after the first smart contract is executed; and after receiving payments corresponding to the debt portfolio, allocating the payments in accordance with the second smart contract.

In some implementations of the present technology, the method further comprises: determining, by the first bot, whether a buyer of a forward-flow agreement (FFA) for the debt portfolio is compliant with the regulations corresponding to debt collection; generating a second smart contract corresponding to giving access to a portion or totality of a plurality of debts in a debt portfolio in the FFA, the second smart contract generating a new virtual network layer and a new virtual ledger; storing the second smart contract in the new virtual ledger; executing the second smart contract; sending a notice of transfer of collection rights for each debt of the plurality of debts based on self-executing regulatory and compliance functions of the first smart contract; and after executing the second smart contract: recording receipt of any debt collections corresponding to the debt portfolio in the new virtual ledger, allocating remittances in accordance with the second smart contract, and storing any termination notices and notices of the forward-flow agreement in the new virtual ledger.

In some implementations of the present technology, the method further comprises: determining, by the first bot, whether an additional corporate user is compliant with regulations corresponding to the respective debt; generating a second smart contract indicating an additional corporate user node taking at least partial ownership of the debt portfolio, the second smart contract generating a new virtual network layer and a new virtual ledger; executing the second smart contract, thereby transferring at least partial ownership of the debt portfolio to the additional corporate user node; and after executing the second smart contract: sending a notice of transfer of ownership for each debt of the plurality of debts based on self-executing regulatory and compliance functions of the second smart contract, recording receipt of any debt collections corresponding to the debt portfolio in the new virtual ledger, allocating remittances in accordance with the second smart contract, and storing any termination notices and notices of syndication agreements in the new virtual ledger.

In some implementations of the present technology, executing the first or second smart contract causes debt repayment of at least one debt of the plurality of debts.

In some implementations of the present technology, the method further comprises: outputting a first user interface displaying the plurality of debts; giving access to the first user interface to a permissioned user for a selection of a debt of the plurality of debts; determining a geographical location corresponding to the selected debt; retrieving regulatory restrictions corresponding to the geographical location; and outputting a second user interface displaying the regulatory restrictions and contact information corresponding to the selected debt.

In some implementations of the present technology, the method further comprises: determining a debtor corresponding to the selected debt; retrieving, from the new virtual ledger, previous debt repayment information corresponding to the debtor; generating a spot valuation for the selected debt by inputting, to an artificial intelligence (AI) algorithm, information corresponding to the selected debt and the previous debt repayment information, wherein the spot valuation comprises an option price expiry; and storing, in the new virtual ledger, the spot valuation for the selected debt.

In some implementations of the present technology, the method further comprises determining available repayment options for the selected debt based on the spot valuation.

In some implementations of the present technology, the method further comprises determining a minimum repayment amount based on an acquisition cost of the selected debt and a carrying cost of the selected debt.

In some implementations of the present technology, the first smart contract indicates one or more corporate user nodes purchasing the debt portfolio.

In some implementations of the present technology, the method further comprises closing the first smart contract after determining that the plurality of debts have been repaid.

In some implementations of the present technology, the method further comprises: determining a write-off value of at least a portion of the debt portfolio containing the plurality of debts, the portion containing uncollectable debts; and closing the first smart contract in the virtual ledger corresponding to the uncollectable debts.

In some implementations of the present technology, the method further comprises: determining a second valuation of the debt portfolio containing a plurality of debts; and generating, based on the second valuation of the debt portfolio, a second smart contract that transfers ownership of the debt portfolio to a second purchaser.

In a second aspect, various implementations of the present technology provide a method comprising:
retrieving, from a virtual ledger, information corresponding to a debt, the information comprising a debtor, a geographical location corresponding to the debt, and an amount of the debt;
determining, based on the information corresponding to the debt, available repayment options for the debt;
retrieving regulatory restrictions corresponding to the geographical location;
generating, based on the debt, a user interface accessible by the debtor associated with the debt, the user interface complying with the regulatory restrictions, and the user interface displaying the available repayment options for the debt;
outputting, to the debtor, the user interface;
receiving, via the user interface, user input indicating a selection of a repayment option of the available repayment options; and
storing, in the virtual ledger, the selected repayment option.

In some implementations of the present technology, the available repayment options comprise paying in full, flexible payments, or negotiation.

In some implementations of the present technology, determining the available repayment options for the debt comprises determining, by an artificial intelligence (AI) algorithm, a spot valuation of the debt that is sufficient and compliant with the regulatory restrictions.

In some implementations of the present technology, determining the available repayment options for the debt comprises determining, by an artificial intelligence (AI) algorithm, a minimum repayment amount based on an acquisition cost of the debt and a carrying cost of the debt.

In some implementations of the present technology, storing a selected repayment option in the virtual ledger comprises: creating a smart contract generating a new virtual network layer and a new virtual ledger, the smart contract corresponding to the selected repayment option, thereby causing payment to be transferred; and storing the smart contract in the new virtual ledger.

In some implementations of the present technology, the method further comprises sending, to a server corresponding to a credit reporting institution, an indication of a payment of the whole or at least part of a settled value of the debt.

In some implementations of the present technology, the method further comprises: receiving an indication that a final payment has been made corresponding to the repayment option; storing, in the virtual ledger, an indication that the debt has been repaid; removing, from a debt portfolio, the debt; sending, to a server corresponding to a credit reporting institution, an indication that the debt has been repaid; and sending, to the debtor, a release that the debt has been repaid.

In some implementations of the present technology, the method further comprises: determining a write-off value of the debt within a portfolio containing a plurality of debts; closing a smart contract, in the virtual ledger, corresponding to the debt; and sending, to a server corresponding to a credit reporting institution, an indication that the debt has been written off.

In a third aspect, various implementations of the present technology provide a method comprising:
outputting to a permissioned user, an interface comprising a selection of debts from a debt portfolio including a plurality of debts;
retrieving, from a virtual ledger, information corresponding to the selection of debts, the information comprising debtors, contact information of the debtors, geographical locations corresponding to the selection of debts, and corresponding amounts of the selection of debts;
determining, based on the information corresponding to the selection of debts, available repayment options; and
retrieving regulatory restrictions corresponding to the geographical locations.

In some implementations of the present technology, the method further comprises: determining a debtor corresponding to a given debt from the selection of debts; retrieving, from the virtual ledger, previous debt repayment information corresponding to the debtor; accessing a minimum repayment amount and available repayment options for the debt, based on a spot valuation generated by an artificial intelligence (AI) algorithm, carrying cost, and acquisition cost; generating a smart contract with the debtor, the smart contract generating a virtual network layer and the virtual ledger after confirming debtor's selected payment option; executing the smart contract, thereby causing payment or future payments to be transferred to the debtor; and storing the smart contract in the virtual ledger.

In some implementations of the present technology, the method further comprises sending, to a server corresponding to a credit reporting institution, an indication of a payment of the whole or at least part of a settled value of the given debt.

In some implementations of the present technology, the method further comprises: receiving an indication that a final payment corresponding to the given debt has been made; storing, in the virtual ledger, the indication that the given debt has been repaid; removing the given debt from the debt portfolio; sending, to a server corresponding to a credit reporting institution, the indication that the given debt has been repaid and a settled value of the debt; and sending, to the debtor corresponding to the debt, a release that the debt has been repaid.

In a fourth aspect, various implementations of the present technology provide a system comprising:
a distributed ledger comprising a smart contract for execution in one or more virtual network layers, the smart contract comprising one or more self-executing functions; and
one or more bots performing at least one task specified by the smart contract and executing within the one or more virtual network layers.

In some implementations of the present technology, the smart contract is selected from a set of pre-defined smart contracts based on a specified use case.

In some implementations of the present technology, the one or more bots retrieve information based on the smart contract.

In some implementations of the present technology, the one or more bots analyze quantitative data and/or qualitative data.

In some implementations of the present technology, the one or more bots store data in the distributed ledger.

In some implementations of the present technology, the one or more virtual network layers link, by executing the smart contract, the one or more bots and one or more user nodes.

In some implementations of the present technology, the system further comprises a network layer comprising the one or more user nodes.

In some implementations of the present technology, the one or more user nodes comprise corporate user nodes and debtor user nodes.

In some implementations of the present technology, the system further comprises a permissioned distributed ledger comprising a data layer storing information in a corporate or debtor database.

In some implementations of the present technology, the one or more virtual network layers link one or more user nodes indicated in the smart contract.

In a fifth aspect, various implementations of the present technology provide a method for generating a spot valuation of a debt, the method comprising:
retrieving information corresponding to the debt from a smart contract stored in a distributed ledger;
retrieving, from the distributed ledger, previous debt repayment information for a debtor of the debt;
inputting, to an artificial intelligence (AI) algorithm, the information corresponding to the debt and the previous debt repayment information, the AI algorithm having been trained using debt repayment information stored in the distributed ledger; and
outputting, by the AI algorithm, the spot valuation of the debt.

In some implementations of the present technology, the spot valuation of the debt comprises a range.

In some implementations of the present technology, the AI algorithm has further been trained to predict the spot valuation for a specific debt collecting organization.

In some implementations of the present technology, the method further comprises retrieving, from the distributed ledger, information indicating historical debt collection results of the specific debt collecting organization, wherein the AI algorithm has further been trained using the information indicating the historical debt collection results of the specific debt collecting organization.

In some implementations of the present technology, an accuracy of predictions from the AI algorithm is improved by retrieving exogenous data and additional previous debt repayment information data from the distributed ledger.

In a sixth aspect, various implementations of the present technology provide a method comprising:
generating a first smart contract corresponding to an obligation portfolio comprising a plurality of obligations, the first smart contract generating a virtual network layer and virtual ledger;
storing the first smart contract in a virtual ledger;
activating, based on self-executing functions of the first smart contract, a first bot to determine whether each obligation in the obligation portfolio and an owner of the obligation portfolio are compliant with regulations corresponding to the respective obligation;
activating, based on the self-executing functions of the first smart contract, a second bot to determine a predicted valuation for the obligation portfolio; and
after confirming, by the first bot, that the obligation portfolio is compliant with the regulations, and confirming, by the second bot, that the predicted valuation is sufficient for the first smart contract, executing the first smart contract.

In a seventh aspect, various implementations of the present technology provide a method comprising:
retrieving, from a virtual ledger, information corresponding to an obligation, the information comprising a beneficiary of the obligation, a geographical location corresponding to the obligation, and a value of the obligation;
determining, based on the information corresponding to the obligation, available compensation options for the obligation;
retrieving regulatory restrictions corresponding to the geographical location;
generating, based on the obligation, a user interface accessible by the beneficiary of the obligation, the user interface complying with the regulatory restrictions, and the user interface displaying the available compensation options for the obligation;
outputting, to the beneficiary of the obligation, the user interface;
receiving, via the user interface, user input indicating a selection of a compensation option of the compensation options for the obligation; and
storing, in the virtual ledger, the selected compensation option.

In an eighth aspect, various implementations of the present technology provide a method comprising:
outputting to a permissioned user, an interface comprising a selection of obligations from an obligation portfolio including a plurality of obligations;
retrieving, from a virtual ledger, information corresponding to the selection of obligations, the information comprising beneficiaries of the obligations, contact information of the beneficiaries of the obligations, geographical locations corresponding to the selection of obligations, and corresponding valuations of the selection of obligations;
determining, based on the information corresponding to the selection of obligations, available compensation options; and
retrieving regulatory restrictions corresponding to the geographical locations.

In a ninth aspect, various implementations of the present technology provide a method for generating a spot valuation of an obligation, the method comprising:
retrieving information corresponding to the obligation from a smart contract stored in a distributed ledger;
retrieving, from the distributed ledger, previous obligation compensation information for a beneficiary of the obligation;
inputting, to a machine learning algorithm, the information corresponding to the obligation and the previous obligation compensation information, the machine learning algorithm having been trained using obligation compensation information stored in the distributed ledger; and
outputting, by the machine learning algorithm, the spot valuation of the obligation.

In the context of the present specification, unless expressly provided otherwise, a computer system or computing environment may refer, but is not limited to, an “electronic device,” a “computing device,” an “operation system,” a “system,” a “computer-based system,” a “computer system,” a “network system,” a “network device,” a “controller unit,” a “monitoring device,” a “control device,” a “server,” a “cloud computing system” or “cloud based network,” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (e.g., CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

Additional and/or alternative features, aspects, and advantages of implementations of the present disclosure will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A depicts a computing environment for a debt portfolio management system, in accordance with various non-limiting embodiments of the present disclosure;

FIG. 1B illustrates a representative high-level functional block diagram of a computing device of the computing environment, in accordance with various non-limiting embodiments of the present disclosure;

FIG. 2 illustrates a high-level functional block diagram of a debt portfolio management system, in accordance with various embodiments of the present disclosure;

FIG. 3 illustrates a process, implemented over the debt portfolio management system, for governing smart contracts, in accordance with various embodiments of the present disclosure;

FIG. 4 illustrates components and interactions of a debt portfolio management application associated with the debt portfolio management system, in accordance with various embodiments of the present disclosure;

FIG. 5 illustrates various functions that may be performed using the debt portfolio management system, in accordance with various non-limiting embodiments of the present disclosure; FIG. 6 illustrates a process of data analysis performed by the debt portfolio management application, in accordance with various non-limiting embodiments of the present disclosure;

FIG. 7 illustrates a process for initial agency onboarding of a corporate user over the debt portfolio management system, in accordance with various embodiments of the present disclosure;

FIG. 8 illustrates various virtual network layers included in a distributed ledger, in accordance with various embodiments of the disclosure;

FIG. 9 illustrates a process of creation of and/or addition of a debt portfolio to a virtual distributed ledger, in accordance with various embodiments of the present disclosure;

FIG. 10 illustrates a process of transferring a debt portfolio, in accordance with various embodiments of the present disclosure;

FIG. 11 illustrates a process of financing a debt portfolio, in accordance with various embodiments of the present disclosure;

FIG. 12 illustrates a process of giving access to at least a portion of the plurality of debts in the debt portfolio via a forward flow agreement (FFA), in accordance with various embodiments of the present disclosure;

FIG. 13 illustrates a process for collection of the debts associated with a debt portfolio, in accordance with various embodiments of the present disclosure;

FIG. 14 illustrates a process for repayment of debts associated with a debt portfolio utilizing collaborative Digital Debtor Self-Serve (DDSS), in accordance with various embodiments of the present disclosure;

FIG. 15 illustrates a process for evaluation of a debt portfolio for sale, write-off and/or termination, in accordance with various non-limiting embodiments of the present disclosure; and FIG. 16 illustrates a process of a method for generating and executing smart contracts, in accordance with various embodiments of the present disclosure.

### DETAILED DESCRIPTION

The examples and conditional language recited herein are principally intended to aid the reader in understanding the principles of the present disclosure and not to limit its scope to such specifically recited examples and conditions. It will be appreciated that those skilled in the art may devise various arrangements which, although not explicitly described or shown herein, nonetheless embody the principles of the present disclosure and are included within its spirit and scope.

Furthermore, as an aid to understanding, the following description may describe relatively simplified implementations of the present disclosure. As persons skilled in the art would understand, various implementations of the present disclosure may be of greater complexity.

In some cases, what are believed to be helpful examples of modifications to the present disclosure may also be set forth. This is done merely as an aid to understanding, and, again, not to define the scope or set forth the bounds of the present disclosure. These modifications are not an exhaustive list, and a person skilled in the art may make other modifications while nonetheless remaining within the scope of the present disclosure. Further, where no examples of modifications have been set forth, it should not be interpreted that no modifications are possible and/or that what is described is the sole manner of implementing that element of the present disclosure.

Moreover, all statements herein reciting principles, aspects, and implementations of the present disclosure, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present disclosure. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present disclosure, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that one or more modules may include for example, but without being limitative, computer program logic, computer program instructions, software, stack, firmware, hardware circuitry, or a combination thereof.

### Computing Environment

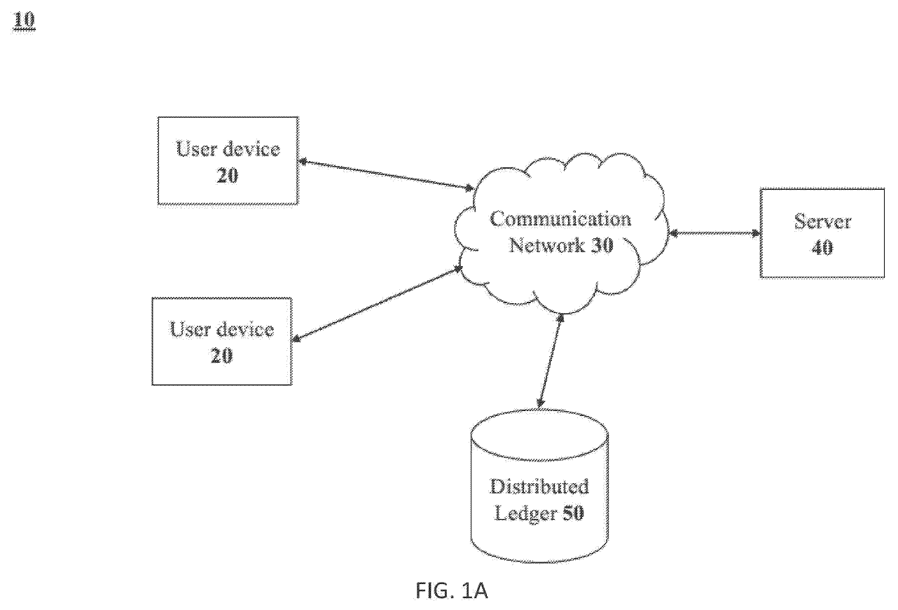

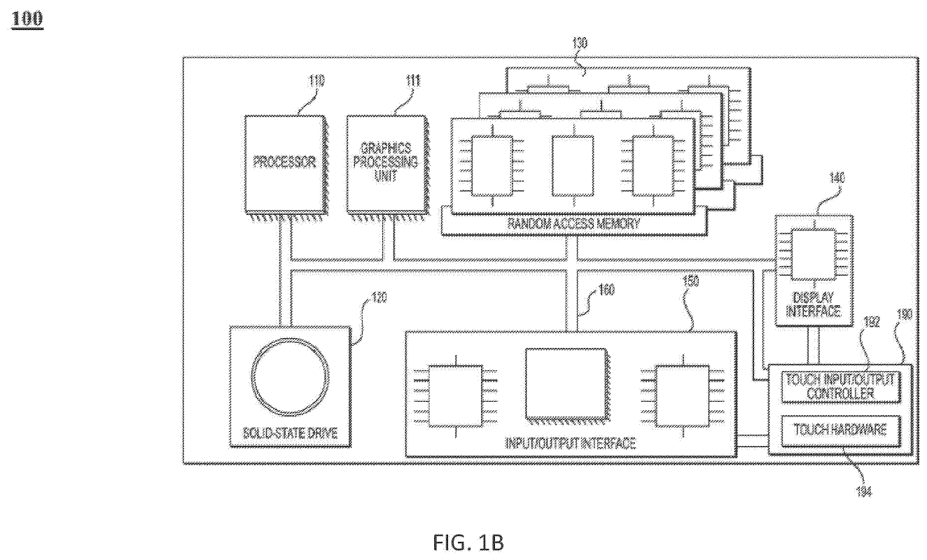

FIG. 1A depicts a computing environment 10 for a debt portfolio management system, in accordance with various non-limiting embodiments of the present disclosure. The environment 10 may include multiple user devices 20 located at different geographic locations that may be configured to communicate with each other via a communication network 30. The user devices 20 may be personal computers, laptops, desktops, tablets, mobile phones or the like or a part of network such as, user devices in an organization, etc. Further, the user devices 20 may communicate with one or more servers 40 (for the purpose of simplicity only one server 40 has been illustrated). The user devices 20 and server 40 may be coupled to one or more virtual distributed ledgers 50. Some or all of the devices illustrated in FIG. 1A may be cloud computing systems and/or form a cloud-based network.

### User Device

FIG. 1B illustrates a representative high-level functional block diagram of a computing system 100, such as the user device 20 and/or server 40, which may be used to implement and/or execute various methods described herein. In some embodiments, the computing system 100 may be implemented by any of a conventional personal computer, a computer dedicated to managing network resources, a network device and/or an electronic device (such as, but not limited to, a mobile device, a tablet device, a server, a controller unit, a control device, etc.), and/or any combination thereof appropriate to the relevant task at hand. In some embodiments, the computing system 100 comprises various hardware components including one or more single or multi-core processors collectively represented by processor 110, a solid-state drive 120, a random access memory 130, and an input/output interface 150. The computing system 100 may be a computer specifically designed to operate a machine learning algorithm (MLA) and/or a deep learning algorithm (DLA), and/or Large Language Model (LLM) and/or generative AI.

These various AI-related technologies, generically called AI algorithms, may be used to perform the various functions described herein. For example, when purchasing a debt portfolio, its current and future predictive value may be ascertained using MLA and/or DLA. In negotiation with a consumer or client through a digital self-serve application, without human intervention on the part of the collector, analysis using several cycles of price discovery of the price of the debt settlement may be calculated in real-time using MLA and/or DLA. Also, when the consumer or client is in contact with operations personnel, an analysis may be made of the price of the debt settlement in real-time, also integrating generative AI and/or LLM To create a smart contract, bots may search/collect/contextualize both endogenous and exogenous information in order to perform valuation, evaluation, and regulatory compliance analysis. The information search may include both numerical data and text, using MLA and/or DLA and/or LLM. Management on the other hand may use MLA and/or DLA to determine current and future cash flow positions generated by the collection operations in order to make decisions of portfolio disposition, bringing on board additional external agencies or determine whether their cash flow allows for the acquisition of new assets or in this case debt portfolios. These data sets may be presented within the management dashboard in a graphic manner to facilitate time frame analysis, using generative AI and/or MLA and/or DLA.

The computing system 100 may be a generic computer system. In some embodiments, the computing system 100 may also be a subsystem of one of the above-listed systems. In some other embodiments, the computing system 100 may be an “off-the-shelf” generic computer system. In some embodiments, the computing system 100 may also be distributed amongst multiple systems. The computing system 100 may also be specifically dedicated to the implementation of the present disclosure. As a person skilled in the art of the present disclosure may appreciate, multiple variations as to how the computing system 100 is implemented may be envisioned without departing from the scope of the present disclosure.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units (GPUs), Tensor Processing Units (TPUs), and/or other so-called accelerated processors (or processing accelerators) may be provided in addition to or in place of one or more CPUs.

System memory will typically include random access memory 130 but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing system 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present disclosure. For example, the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a screen 190 and/or to the one or more internal and/or external buses 160. The screen 190 may be part of the display. In some embodiments, the screen 190 is the display. The input/output interface 150 may be a projected display, holographic display, augmented or virtual reality display, and/or any other type of display. The input/output interface 150 may be integrated into a virtual or augmented reality headset, watch, smartphone, tablet, and/or any other type of device.

The screen 190 may equally be referred to as a touchscreen 190. In the embodiments illustrated in FIG. 1B, the screen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computing system 100 in addition to or instead of the screen 190. The input/output interface may be connected to a device implementing Gesture Recognition Technology (GRT), which may allow a user to interact with the system via gestures and voice command.

According to some implementations of the present disclosure, the solid-state drive 120 stores program instructions suitable for being loaded into the random-access memory 130 and executed by the processor 110 for executing acts of one or more methods described herein. For example, at least some of the program instructions may be part of a library or an application.

It is to be noted that the computing system 100 is shown as a standalone computer. However, the implementation of various other embodiments of the present disclosure may include any client-server model where client devices may run a client version of the application programs related to a debt portfolio management system. Other examples of the computing system 100 may include a distributed computing system that runs the server version of the application programs related to the debt portfolio management system, a virtual machine (or virtual machines) instantiated by the infrastructure of a public or private cloud, or a cloud service provider that provides the application programs related to the debt portfolio management system. The systems and functions described herein may be provided as a system-as-a-service (Saas) or a platform-as-a-service (PaaS), such as using a cloud computing environment. Such implementations or any other similar implementation should not limit the scope of the present disclosure.

### Distributed Ledger

The distributed ledger 50 contains a record of business or financial transactions. It may be constructed in the form of a database that is consensually shared across the user devices 20 and the server 40. The distributed ledger 50 may be a virtual distributed ledger being synchronized between the devices 20 and the server 40, and/or may be any other type of ledger. The distributed ledger 50 may be described as a ledger of any data, transactions, and/or contracts maintained in decentralized form across different user devices 20 and the server 40.

The distributed ledger 50 may independently, concurrently, or consensually, update, or modify individual copies of the ledger. The distributed ledger 50 may include security measures and cryptographic functions for signing, concealing, and/or verifying content. After data has been written to the distributed ledger 50, it might not be possible to edit the data written to the distributed ledger 50. In this manner, the distributed ledger 50 may contain an unalterable record of the prior transactions that have occurred on the distributed ledger 50.

It is contemplated that data in the distributed ledger 50 may be organized in any format such as tables, lists, binary streams of data, or the like which may depend on convenience, source of data, type of data, environment, applications, and the like.

In some embodiments, the distributed ledger 50 may be implemented as decentralized physical databases. In other embodiments, the distributed ledger 50 may be implemented using cloud technology. The distributed ledger 50 includes a consensus mechanism to prevent unwanted alteration of the record contents. In the same or other embodiments, blockchain technology may be used to further prevent unwanted alteration of the contents recorded in the distributed ledger 50. The distributed ledger 50 may be a virtual database, in which case the distributed ledger 50 may be referred to as a virtual ledger.

The distributed ledger 50 may store data relating to a debt portfolio. The data stored in the distributed ledger 50 may include data relating to the debts in the debt portfolio, data relating to communications with the debtors, data relating to any payments that have been received, data relating to any negotiations with the debtors, data relating to regulatory compliance, data relating to an owner of the debt portfolio, data relating to any parties that have a financial interest in the debt portfolio, data relating to agents that are authorized to collect on any of the debts in the portfolio, and/or any other data relating to a debt portfolio.

The terms virtual ledger and distributed ledger (and similar terms) as utilized herein should be understood broadly and may be used interchangeably among various embodiments of the present disclosure.

### Debt Portfolio Management System

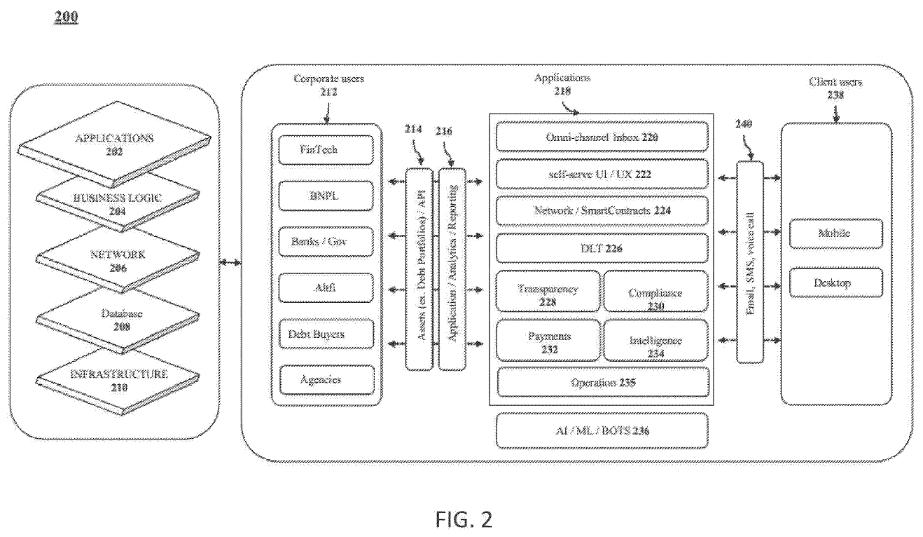

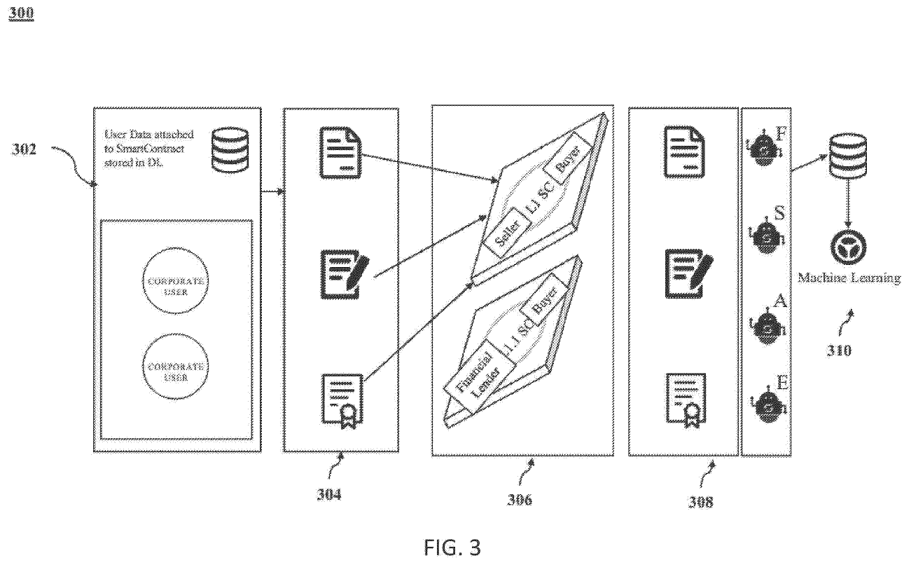

FIG. 2 illustrates a high-level functional block diagram of a debt portfolio management system 200, in accordance with various embodiments of the present disclosure. The debt portfolio management system 200 may be a comprehensive real-time debt portfolio valuation, smart contract creation, auto-resolving (digital self-serve) client debt recovery and operations platform powered by artificial intelligence (AI) including MLA. Use of other AI techniques, including for example and without limitation DLA and LLM, is also contemplated. The debt portfolio management system 200 may perform data analytics, manage self-executing smart contract agreements, retrieve information from public documents pertaining to regulatory compliance and/or financial health (Web scraping). The debt portfolio management system 200 may implement ELK (Elastic Search), OCR (optical character recognition), NLP (natural language processing) and/or other techniques. In the context of the present disclosure, a smart contract may be understood as a computer program, or a sequence of computer-executable instructions, aimed at automating the execution of a transaction, for example a financial or legal transaction. In an embodiment, the smart contract may rely on distributed ledger and /r blockchain technology to protect the transaction from undesired tampering.

The debt portfolio management system 200 along with its analytic feature may operate as an intelligent layer on top of current management process and may deliver a deeper visibility and insights across the smart contract repository.

The debt portfolio management system 200 may include various virtual network layers. By way of example, the virtual network layers may include an application layer 202, a business logic layer 204, a network layer 206, a database layer 208, and an infrastructure layer 210. The virtual network layers may assist the debt portfolio management system 200 in implementing various embodiments of the present disclosure. For example, bots may execute in the virtual network layers. Virtual network layers come into existence with the initiation of any smart contract. They are active conduits not only between counterparties but also between various types of users and the platform itself. Virtual network layers hold the contents and executable functions of the individual (specific and unique) smart contract as well as the virtual ledger which holds the data. The virtual network layer is therefore a temporary construct encompassing the transaction time frame and through which bots operate, in conjunction with data in the distributed ledger and/or exogenous information, for example set up of smart contract for any reason—portfolio evaluation, purchase, financing, operations, and the like. The virtual network layer is extinguished once all the parameters of a smart contract have been fulfilled and recorded in the distributed ledger. The distributed ledger is the layer containing original and amended records. Data is also recorded within the distributed ledger. The smart contract operating in conjunction with the virtual network layer saves time and computational energy that are implicit for traceability and accountability as opposed to traditional blockchain or Ethereum consensus mechanisms. The virtual ledger is a record of transactions between counterparties as outlined and managed through the executable smart contract—it exists within the virtual network layer, temporarily during the time frame of the smart contract, i.e., until all terms and conditions have been satisfied or, in the instance of a debt portfolio, when it is written off. Its contents/changes/additions/transactions are recorded (i.e., mirrored) in the permanent distributed ledger.

The application layer 202 may include various applications 218 associated with the debt portfolio management system 200. The applications 218 may include user interfaces and application programming interfaces (APIs) for automated Voice over Internet Protocol (VOIP) communications, payments, and/or accounting. The application layer 202 may include a debt portfolio management application 216, an omni-channel inbox 220, a self-serve user interface (UI)/user experience (UX) 222, a smart contract application 224, a distributed ledger technology (DLT) application 226, a transparency application 228, a compliance application 230, a payment application 232, an intelligence application 234, and/or an operations application 235.

The business logic layer 204 may include messaging connectivity and execution business logic to ensure interoperability of the debt portfolio management system 200. The business logic layer 204 may facilitate communications 240 between different users/clients operating the debt portfolio management system 200. By way of example, the business logic layer 204 may facilitate the communication 240 between different users/clients by means of emails, SMSs, voice calls, or the like.

The network layer 206 may include corporate users 212 and client users 238. The smart contract application 224 may generate virtual network layers and virtual distributed ledgers that interact with the corporate users 212 and/or the client users 238. The network layer 206 may further include context/content sensitive artificial intelligence (AI)/machine-learning based bot ecosystem 236. The bots in the bot ecosystem 236 may be configured to fetch data, store data, analyze data, execute functions, and/or perform other tasks. The bot ecosystem 236 may include fetch bots, analyze bots, store bots, and execute bots. The bots in the bot ecosystem 236 may perform tasks specified by a smart contract. The bots in the bot ecosystem 236 may execute within the one or more virtual distributed ledger network layers. The bots may retrieve information based on a smart contract. The bots may analyze quantitative or qualitative data. The bots may store data in the distributed ledger 50.

The fetch bots may retrieve information that is context/content sensitive. The analyze bots may be capable of analyzing both qualitative and quantitative data. The analyze bots may implement machine learning and/or deep learning and/or generative AI processes, as mentioned hereinabove. The analyze bots may implement any one or more of data augmentation and synthesis, anomaly detection, predictive analytics, natural language processing (NLP), image and video analysis, and personalization. The store bots may record information that is context/content sensitive in the appropriate distributed ledger user(s) database and/or may establish consensus between related user nodes in the smart contract database. The execute bots may perform tasks specific to a smart contract. Each of these types of bot may be programmable and/or configurable.

The database layer 208 may include distributed ledgers 50 and may store information/data associated with the corporate users 212 and client users 238. The database layer 208 may include data relating to debt portfolios. The data relating to a debt portfolio may include spreadsheets, databases, tables, lists, and/or any other compilation of information describing debts or purported debts owed by the client users 238. The individual debts may be an agreement related to an asset 214 that is borrowed, transferred, or assigned, and that is expected to be returned in kind (e.g., money borrowed, and money returned). Asset 214 may include money, property, time, physical objects (e.g., artworks, commodities, jewelry), virtual objects, services, a legal right (e.g., life insurance or other insurance types), an obligation to deliver a service, a depreciation amount, a credit, an agreed assumption of a risk or liability, and/or any combination thereof.

In contexts where the asset 214 is not a financial asset, the term “debt” may be substituted with “loan” when the asset includes a physical object being loaned. More generally, the term “debt” may be substituted with “obligation”, which may apply to financial assets, to physical assets, or to other types of pledges, commitments, or engagements, being borrowed or taken by a client, or transferred or assigned between a client or borrower of the asset and a beneficiary of the obligation. In such contexts, an object on loan may be returned, and compensation (financial or other) may be provided to the beneficiary in response to the obligation taken by the client or borrower. The following non-limiting examples will mainly discuss debts as financial assets in order to illustrate the various aspects of the disclosed methods and systems. It should however be appreciated that the present technology may be applied to managing obligation portfolios for any type of tangible or intangible assets, whether compensation is in monetary form or otherwise.

A debt may be based on a formal or informal agreement between the client user 238 (for example, a borrower) and the corporate user 212 (for example, a lender), wherein the corporate user 212 may provide the asset 214 to the borrower for a predefined amount of time, a variable period of time, or indefinitely. The client users 238 and the corporate users 212 may be individuals, entities, corporations, governments, groups of people, organizations, financial technology companies (FinTechs), Buy Now, Pay Later (BNPL) providers, banks, debt buyers and/or any other such agency. The corporate user 212 may be the organization that issued the debt or may be an organization that acquired the debt, such as by purchasing a debt portfolio.

Debt types may include mortgage loans, personal loans, secured loans, unsecured loans, concessional loans, commercial loans, microloans, and the like. The agreement between the corporate user 212 and the client user 238 may specify terms of the loan. The client user 238 may be required to return the asset 214 or repay with a different asset than was borrowed. In some cases, a debt may require interest to be repaid on the borrowed asset 214. The corporate user 212 and the client user 238 may be intermediaries between other entities and may never possess or use the asset 214. In some embodiments, a debt may not be associated with direct transfer of goods but may be associated with usage rights or shared usage rights.

In certain embodiments, the corporate user 212 may manage the acquisition of assets 214 (for example, debt portfolios) from debt originators such as banks or debt buyers. Before a debt portfolio is purchased, or leased via a forward flow agreement (FFA), the debt portfolio management application 216 may analyze the debt portfolio and associated data in order to estimate a value of the individual loans in the debt portfolio and/or the entire debt portfolio. The valuation may be specific to the corporate user 212. For example, the valuation may be based on past performance of the corporate user 212.

The process of asset acquisition or financing may be managed through a smart contract that determines at least a portion of the terms and conditions of the loans. The smart contract, when executed, may commit the corporate user 212 and/or the client user 238 to the terms of the smart contract. The smart contract may bind the corporate user 212 and the client user 238 to an immutable and transparent agreement. The smart contract may have self-executing functions. The self-executing functions may include: (a) due diligence pertaining to the corporate user 212 and the client user 238 to determine both regulatory compliance and financial health; (b) determination of the valuation of the asset 214 to be transacted; (c) automated payment (or remittance) execution. After the elements of the due diligence have been satisfied and the agreed valuation has been confirmed, the smart contract may be executed and recorded in the distributed ledger 50.

In certain embodiments, at least a portion of the distributed ledger 50 may be permissioned so that the corporate user 212 have different permissions to access the data in the distributed ledger 50 as compared to the permissions of the client users 238. For example and without limitation, the corporate users 212 may be granted access data related to the debts in the debt portfolio, whereas the client users 238 may only have access to information related to their own debts.

The smart contract recorded to the distributed ledger 50 may perform the functions indicated within the smart contract, such as payments (purchase or remittances) between counterparties (the corporate user 212 and the client user 238) in real time. Any transaction of money (within a time scale) may be integrated into the debt portfolio management application 216. After a transaction is recorded, the applications 218 may update the analytics that determine asset performance and secondary decision processes relating to disposition of the portfolio, such as new forward-flow agreements, sale of the portfolio, write-offs, etc.

It is to be noted that in the debt portfolio management system 200, the corporate users 212 including the sellers or the buyers of the debt portfolio may be in the same network. The corporate users 212 may have access to the network resources (for example, distributed ledger 50) in a permissioned manner. In other words, each corporate user 212 may have a limited access depending on the level of permission granted by the debt portfolio management system 200.

Prior to buying a portfolio, the corporate user 212 may analyze the debt portfolio using the debt portfolio management system 200 integrated with MLAs and generative AI. In certain embodiments, the debt portfolio management system 200 may facilitate various tasks for the corporate users 212 (for example, debt buyers), in the analysis of the debt portfolios prior to purchasing a debt portfolio, leasing a debt portfolio via a forward-flow agreement, or otherwise gaining an interest in a debt portfolio.

In addition to an analysis of the portfolio prior and post purchase or lease, the debt portfolio management application 216 integrated with MLAs and generative AI may continue to work in the background as an analytic tool that further defines viability or revenues. Any transaction of money (within a time scale as recorded in the client database) may be identified by the debt portfolio management application 216. As new transactions are recorded, for example using distributed ledger and/or blockchain technology, the debt portfolio management application 216 integrated with MLAs and generative AI may update analytics of the debt portfolio to determine a performance of the debt portfolio. These analytics may be used for various purposes, such as decisions relating to disposition of the debt portfolio.

The debt portfolio management application 216 integrated with MLAs and generative AI, may be the primary analytics tool that determines portfolio valuations prior to acquisition (as a management negotiation tool) and post-acquisition in real time. In certain embodiments, the debt portfolio management application 216 integrated with MLAs and generative AI may also generate an individual best-case debt recovery scenario, facilitate on the collaborative client portal (for example, the self-serve UI/UX 222) during online negotiations, make an offer, and/or schedule payment processes.

The corporate users 212 (for example, debt recovery agents/permissioned users) may be provided an interface (integrated with the debt portfolio management application 216 integrated with MLAs and generative AI) to define repayment options during their interactions with client users 238 (debtors). Parameters of the repayment options may be configured for authorized agents of the corporate users 212.

The debt portfolio management application 216 integrated with MLAs and generative AI may operate transparently within the distributed ledger, with the capability to access and/or update portfolio databases. The debt portfolio management application 216 integrated with MLAs and generative AI may allow the corporate users 212 to input various endogenous variables such as principal amount of debt, interest, time frame and agency conditions to set the parameters of a debt structure that may impact running costs, cash flow, and/or profitability.

In an embodiment, the debt portfolio management application 216 integrated with MLAs and generative AI may utilize linear regression analysis and/or classification of multiple datasets within the scope of applying neural networks models that depend on the fact that they take non-linear functions of linear combinations of the (specific) inputs. In this way, the neural networks and generative AI may adapt their models more accurately to the data and put more weight on more “important” variables when examining and overlay mapping of legacy datasets located in the distributed ledger 50.

One of the advantages of the linear regression model, for example to generate cluster analysis, is its simplicity and easy interpretation of the effect for the explanatory variables on the response variable. Another advantage of the linear regression model is the fact that the least square estimation is not a computationally heavy procedure which may be time efficient as compared to other techniques.

In certain embodiments, the neural networks may rely on a comprehensive set of independent variables. The variables may be categorized in four groups of characteristics: contract (for example, exposure), debtor (for example, characteristics such as age, credit score, etc.), relationship (for example, age of the account or accounts) and spatial characteristics (for example, externalities such as unemployment rates, population density, number or delinquent accounts in collections, area of residence or postal codes, etc.).

In certain embodiments, the debt portfolio management application 216 integrated with MLAs and generative AI may utilize meta learning assessment, algorithm ensemble stacking, voting, boosting, and bagging techniques to determine a task-specific application. Some of the non-limiting examples of the task may include pre-acquisition negotiation of the portfolio, client user self-serving pricing negotiation, operation pricing negotiations, write-offs, forward-flow agreements, or the like.

In certain embodiments, the debt portfolio management application 216 integrated with MLAs and generative AI may rely on transfer learning, a technique that includes using knowledge from previous prediction tasks to acquire new knowledge in the current task. It is to be noted that previously acquired knowledge may be helpful for future prediction. Such consideration may provide additional latent information that may be transferred during the training process and the transfer learning method may be used to improve performance in the debt portfolio appraisal, purchase price negotiation, individual client debt settlement domain, or the like.

Independent, exogenous and/or endogenous variables may be used for the calculation of price (either portfolio or debt settlement). Each calculation may generate information for a specific periodic cycle and may contribute new information used in transfer learning.

In certain embodiments, the debt portfolio management application 216 integrated with MLAs and generative AI may generate any combination of infographic data. The infographics generated for management decisions (buy, sell, forward-flow agreements, write-offs, financing of debt portfolios, agency performance, regulatory compliance, etc.) may be different from those generated for operations (client debt settlement interaction, individual performance measures).

As previously noted, in addition to the debt portfolio management application 216 integrated with MLAs and generative AI, the debt portfolio management system 200 may include the compliance application 230 integrated with LLM and generative AI. The compliance application 230 integrated with LLM and generative AI may allow the corporate users 212 to monitor compliance with both federal and state regulatory requirements. The compliance application 230 integrated with LLM and generative AI may maintain and monitor the regulatory compliance health of the corporate users 212. The compliance application 230 integrated with LLM and generative AI may service the due diligence elements of smart contract generation, provide real-time compliance updates, flag issues to facilitate remediation and reports of users and counterparties, and/or perform other compliance tasks.

The compliance application 230 integrated with LLM and generative AI may assist in registering the corporate users 212 and the client users 238 in new jurisdictions. The compliance application 230 integrated with LLM and generative AI may interact with bots in the bot ecosystem 236 to verify compliance of a debt portfolio. The compliance application 230 integrated with LLM and generative AI may activate different bots to perform various tasks associated with verification of compliance. The compliance application 230 may determine if the corporate user 212 and/or a given debt portfolio in the assets 214 are compliant with the relevant regulations (for example, state and federal regulatory agencies).

The operations application 235 integrated with MLAs and generative AI may be used to negotiate a payment plan and/or collect payment from the client users 238. The operations application 235 may have permissioned access to predetermined elements of a debt portfolio to perform their debt collection function. The operations application 235 may be enabled to view client users 238 and the associated profiles (create updates to the client database), make contact via automated and regulatory compliant VOIP telephone calls, negotiate a settlement of valid debt, and/or record an agreement in a client smart contract. The operations application 235 may have access to the analytics and performance metrics of the debt portfolio.

The infrastructure layer 210 may provide the hardware, software, cloud, and security infrastructure to the debt portfolio management system 200.

### Evaluating and Acquiring a Debt Portfolio

FIG. 3 illustrates a process 300 which may be executed by the debt portfolio management system 200. The process 300 may govern smart contracts in accordance with various embodiments of the present disclosure. At step 302 of the process 300, the debt portfolio management system 200 receives a request from a corporate user 212 to generate a smart contract corresponding to a debt portfolio (for example, a debt portfolio included in the asset 214).

At step 304, the debt portfolio management system 200 generates the smart contract corresponding to the debt portfolio. In certain embodiments, the smart contract application 224 integrated with MLAs and/or DLAs and/or LLM and/or generative AI may generate the smart contract in at least three stages: initiation, information (retrieval, verification, analysis, placement), and execution. The smart contract application 224 integrated with LLM and/or generative AI may select the smart contract from a set of predefined smart contracts based on a specified task. A predefined smart contract template for transfer of a debt portfolio may be retrieved and used to generate the smart contract.

At step 306, the initiation of the smart contract creates a virtual network layer and virtual distributed ledger layer defining a relationship between the two corporate users 212. By way of example, the two corporate users 212 maybe a debt portfolio seller and a debt portfolio buyer. In another example, the two corporate users 212 may be a financial lender and a debt portfolio buyer. The relationship may define a set of rules, associated with the debt portfolio, to be abided by the two corporate users 212.

At step 308 the bots may be initiated. The bots may execute within the virtual network layer and virtual distributed ledger layer. The bots may perform actions based on the smart contract. The smart contract may dictate which bots should be initiated and which actions the bots should perform.

At step 310, the bots of the bot ecosystem 236 perform data tagging. The bots may retrieve data and generate features, fields, and/or variables. The bots may format the debt portfolio in the distributed ledger 50 prior to engaging a task-specific machine learning process.

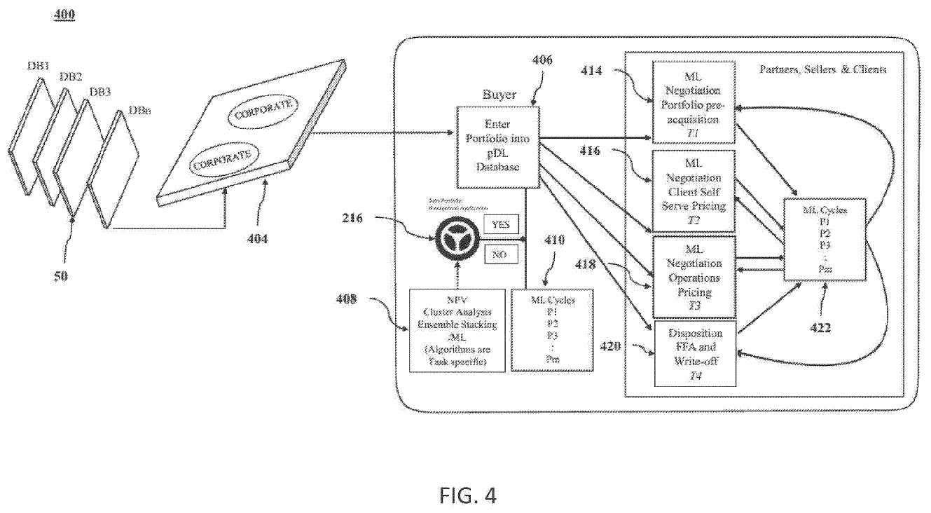

FIG. 4 illustrates components and interactions of the debt portfolio management application 216 in accordance with various embodiments of the present disclosure. To analyze a debt portfolio, the debt portfolio management system 200 may enter the debt portfolio from the distributed ledger 50 to a permissioned distributed ledger (pDL) database layer 404. The pDL database layer 404 may provide the debt portfolio to a component 406 for an analysis to be performed by the debt portfolio management application 216.

The debt portfolio management application 216 may take the debt portfolio as input from the component 406 and perform data scrubbing. In certain embodiments, the bot ecosystem 236 performs tagging of the features and/or fields in the data of the debt portfolio. The component 406 may provide the scrubbed and tagged data for various tasks.

Based on the tasks to be performed, the component 408 may select a suitable MLA from a group of MLAs (or select a suitable DLA from a group of DLAs). The debt portfolio management application 216 may process the debt portfolio in accordance with the selected MLA or DLA. The component 410 may compute performance measurements for machine learning (or deep learning) and generative AI cycles P1, P2, P3, . . . Pm which are specific to each task: T1, T2, T3, . . . Tn.

The component 406 may provide the debt portfolio and/or data from the debt portfolio to the different tasks. By way of example, the tasks may include portfolio pre-acquisition tasks 414 (T1), client self-serve pricing tasks 416 (T2), an operations pricing tasks 418 (T3) and a portfolio disposition task 420 (T4).

The task 414 may determine a valuation of a debt portfolio, determine regulatory compliance of the debt portfolio, and/or perform other tasks relating to the acquisition of the debt portfolio. The task 416 may determine debt repayment options for clients interacting with a debt repayment user interface. The task 418 may provide debt repayment options to an operator interacting with the client, such as a call-center worker. The task 420 may assist in disposing a debt portfolio, such as by writing off the debt portfolio, selling the debt portfolio, etc. Based on the results of the tasks 414, 416, 418, and/or 420, the debt portfolio management application 216 may provide various interfaces to the corporate users 212.

The tasks 414, 416, 418, and/or 420 may implement various MLAs or DLAs, or generative AI. The outcomes of the tasks 414, 416, 418, and 420 may be improved by the component 422 by performing further training of the MLAs or DLAs, or generative AI.

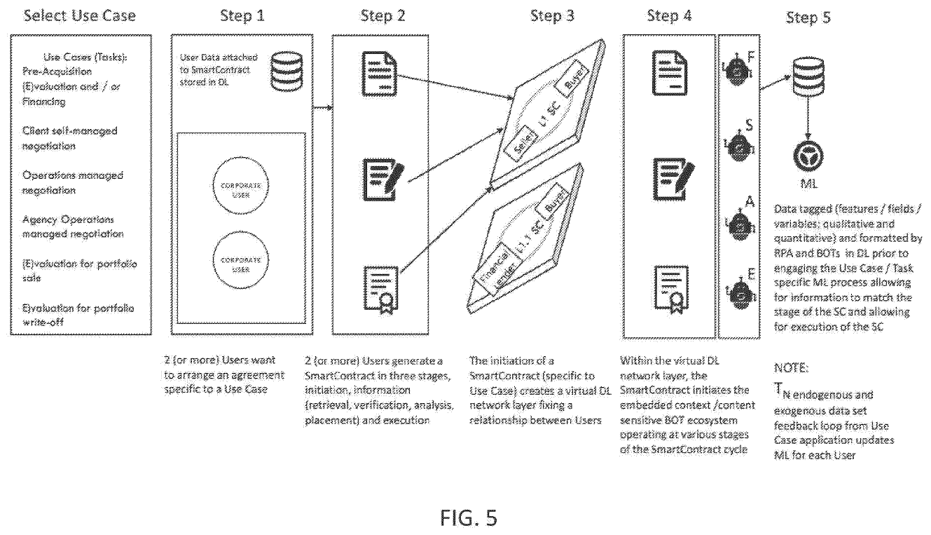

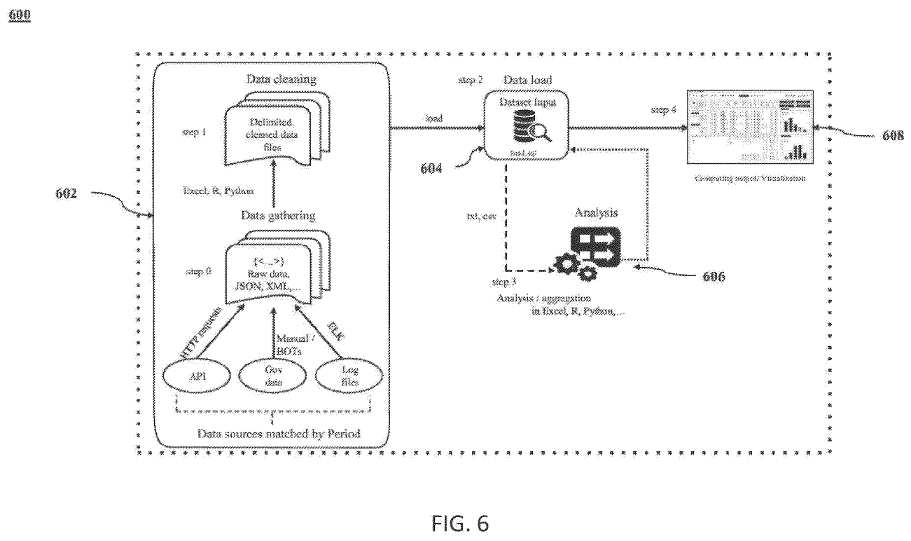

FIG. 5 illustrates an overview of various functions that can be performed using the debt portfolio management system 200. As will be discussed in further detail below, the debt portfolio management system 200 can be used for evaluating a debt portfolio, arranging financing for acquisition of a debt portfolio, managing repayment for debtors, evaluating a debt portfolio for disposition, and other functions.

FIG. 6 illustrates a process 600 of data analysis performed by the debt portfolio management application 216, in accordance with various non-limiting embodiments of the present disclosure. As shown, the process 600 commences at step 602, where the debt portfolio management application 216 performs gathering and cleaning of data. The data may be retrieved from various sources using an application programming interface (API), bots, manual retrieval, and/or other methods.

At step 604 the data is loaded into a database. The database may be interacted with using server query language (SQL). At step 606, the debt portfolio management application 216 may analyze the data. At step 608, the debt portfolio management application 216 may provide the analysis in the form of infographics and reports displayed on a user interface (UI).

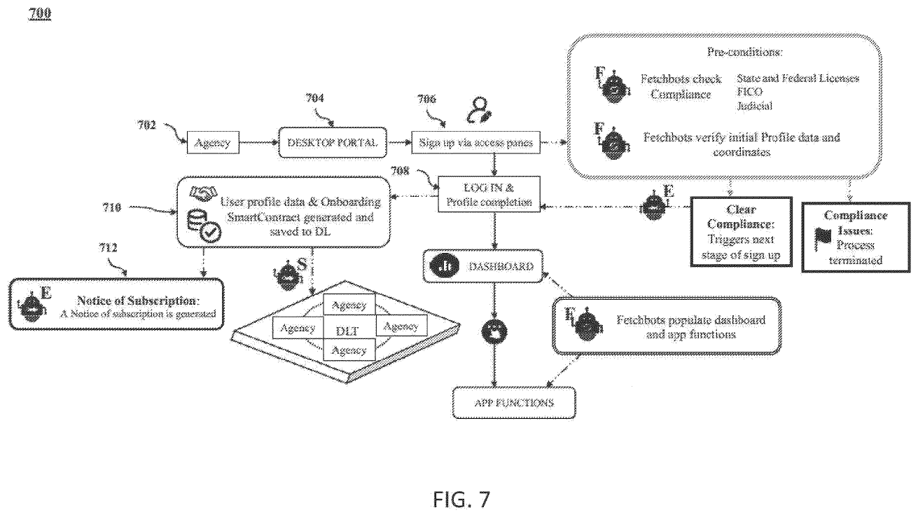

FIG. 7 illustrates a process 700 for initial agency onboarding of the corporate user 212 to the debt portfolio management system 200, in accordance with various embodiments of the present disclosure. As shown, the process 700 commences at step 702, where the corporate user 212 provides a request to the debt portfolio management system 200 for onboarding. In certain embodiments, the request may be provided using the user device 20.

At step 704, the debt portfolio management system 200 provides a portal to the corporate user 212. In certain embodiments, the debt portfolio management system 200 may provide the portal by displaying the portal on the screen 190 of the device 20.

At step 706, the debt portfolio management system 200 may perform a sign up procedure for the corporate user 212. To do so, the debt portfolio management system 200 may perform a compliance check for the corporate user 212. The debt portfolio management system 200 may activate the bot ecosystem 236. The fetch bots may verify that the corporate user 212 is compliant with the regulations (such as, state, and federal regulatory agencies) and may verify the profile of the corporate user 212. In the event that an issue (for example, the corporate user 212 is not in conformity with the regulatory agencies) with compliance is identified, the debt portfolio management system 200 may terminate the onboarding process of the corporate user 212. In the event that the corporate user 212 is in compliance with the regulatory agencies, the debt portfolio management system 200 may trigger the next step of the onboarding.

At step 708, the debt portfolio management system 200 facilitates the corporate user 212 to login to the portal and complete the user profile. In certain embodiments, the corporate user 212 may enter various associated information in the portal. Once the profile is completed, the debt portfolio management system 200 may provide a dashboard to the corporate user 212 by displaying the dashboard on the screen 190 of the device 20.

At step 710, the debt portfolio management system 200 may generate an onboarding smart contract. The store bots may store the generated onboarding smart contract in the distributed ledger 50. Finally, at step 712, the execute bots generates a notice of subscription for the corporate user 212.

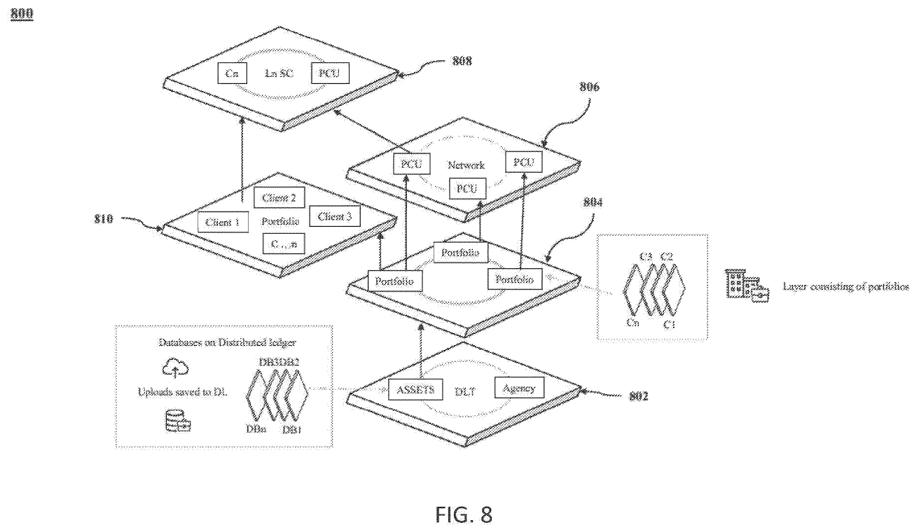

FIG. 8 illustrates various virtual network layers 800 included in the distributed ledger 50, in accordance with various embodiments of the disclosure. As shown, the virtual network layer 802 may include a data layer and store information for context/content-sensitive bots to manage consensus. The virtual network layer 804 may include one or more debt portfolios. The virtual network layer 806 may be a network layer consisting of permissioned internal corporate user (PCU) nodes. The virtual network layer 808 may be generated by a smart contract between PCU nodes (on behalf of the portfolio owner) and client nodes and the context/content-sensitive bot ecosystem. The virtual network layer 810 may be a portfolio layer including client user nodes.

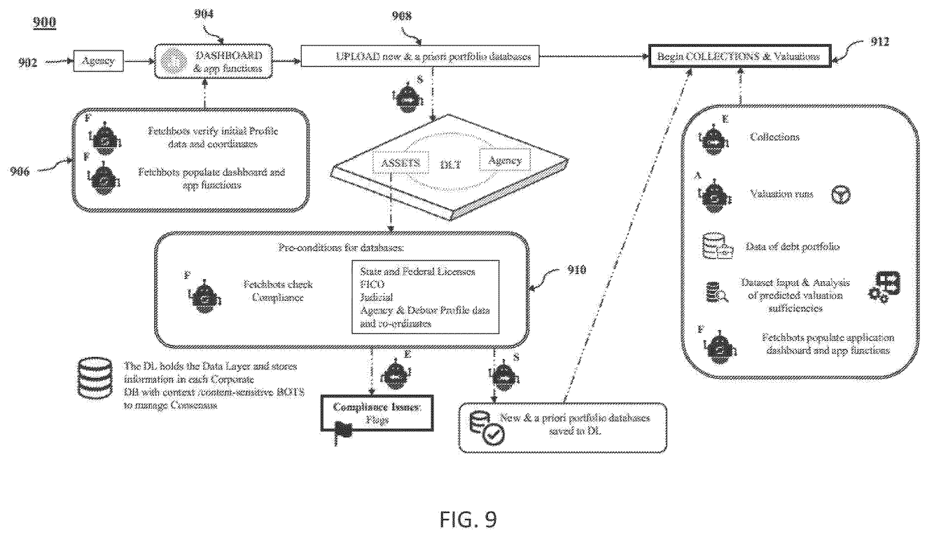

FIG. 9 illustrates a process 900 of creation of and/or addition of a debt portfolio to a distributed ledger 50, in accordance with various embodiments of the present disclosure. As shown, the process 900 commences at step 902, where the corporate user 212 provides a request to the debt portfolio management system 200 for creation of and/or addition of a debt portfolio to a distributed ledger 50. In certain embodiments, the request may be provided using the user device 20.

At step 904, the debt portfolio management system 200 provides the dashboard and the application functions to the corporate user 212. In certain embodiments, the debt portfolio management system 200 may provide the dashboard and the application functions by displaying the portal on the screen 190 of the device 20. In certain embodiments, prior to providing the dashboard and the application functions, the fetch bots may verify the initial profile data and coordinates. Once the initial profile data and coordinates are verified, the fetch bots may populate the screen 190 of the device 20 with the dashboard and the application functions.

At step 908, the debt portfolio management system 200 saves a new or existing debt portfolio to the virtual network layer (for example, virtual network layer 802) of the distributed ledger 50. In certain embodiments, the store bots save the new or existing debt portfolio to the virtual ledger.

At step 910, the fetch bots may verify that the debt portfolio is compliant with the applicable regulations, such as debt collection regulations promulgated by state and federal regulatory agencies. In the event that an issue with the compliance is identified, such as when actions taken relating to a debt are not compliant with the regulations, the bots may terminate the saving process and/or may remove the debt portfolio from the distributed ledger. In the event that the debt portfolio is in compliance with the regulations, the store bots may save the debt portfolio in the distributed ledger 50.

Finally, at step 912, the debt portfolio management system 200 may assist in debt collection for debts in the debt portfolio and/or valuation of the debt portfolio.

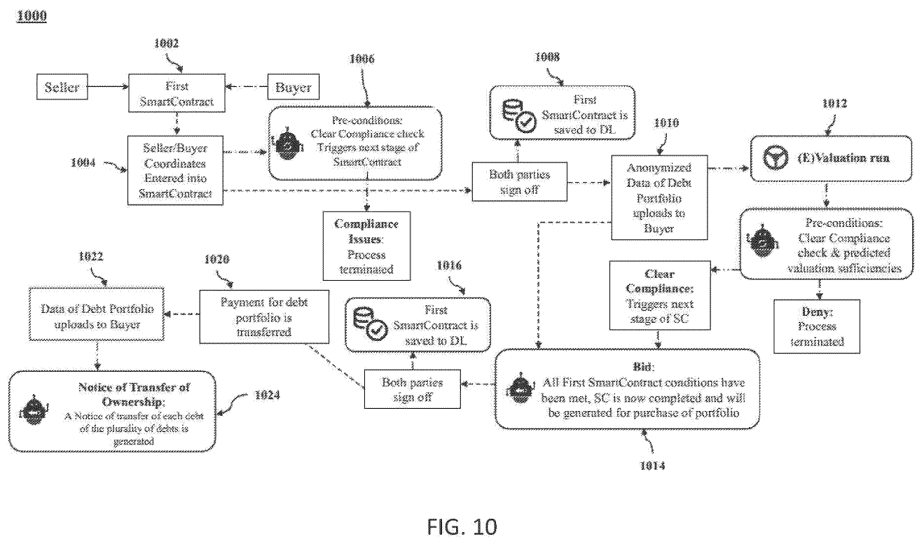

FIG. 10 illustrates a process 1000 of transferring a debt portfolio, in accordance with various embodiments of the present disclosure. As shown, the process 1000 commences at step 1002, where a corporate user 212, such as a seller of the debt portfolio or a buyer of the debt portfolio, provide a request to the debt portfolio management system 200 for transferring the debt portfolio. In certain embodiments, the request may be provided using the user device 20. The corporate user 212 may enter the respective coordinates (for example, login credentials) on the portal/application/UI associated with the debt portfolio management system 200.

At step 1002, the smart contract application 224 may generate a first smart contract corresponding to the transfer of the debt portfolio.

At step 1004, the fetch bots may verify the respective coordinates. Once the coordinates are verified, the fetch bots may populate the screen 190 of the device 20 with a dashboard and application functions. The smart contract application 224 may record the credentials of the corporate users 212 in the smart contract. The coordinates may indicate the buyer, seller, and/or any other parties involved in the transaction.

At step 1006, the fetch bots may verify that the corporate users 212, such as the buyer, seller, and any other parties involved with the transaction, are compliant with the applicable regulations. In the event that an issue with the compliance is identified, the execution bots may terminate the transfer process. In the event that the corporate users 212 are in compliance with the regulatory agencies, the process advances to step 1008.

At step 1008, the smart contract application 224 may store the smart contract to the distributed ledger. Involved parties may sign off on the smart contract prior to the smart contract being stored in the distributed ledger.

At step 1010, the store bots may anonymize data from the debt portfolio and upload the anonymized data to the debt portfolio buyer and/or any other interested parties. The anonymized data may be saved to a permissioned distributed ledger associated with one of the corporate users 212, such as the distributed ledger of the buyer of the debt portfolio. The data associated with the debt portfolio may be anonymized by the debt portfolio management application 216 in order to remove any personally identifiable information (PII) from the debt portfolio.

At step 1012, the compliance application 230 may verify that the debt portfolio is compliant with applicable regulations and/or determine a valuation of the debt portfolio. In the event that an issue with the compliance is identified, the execution bots may flag the issue and/or terminate the transaction. The debt portfolio management application 216 may determine a predicted valuation of the debt portfolio by determining a value of each individual debt in the portfolio. The individual values may be determined using one or more bots. The valuation may be specific to the buyer of the debt portfolio, and may be based on historical data corresponding to the buyer.

In the event that the debt portfolio is in compliance with the applicable regulations and the predicted valuation of the debt portfolio is sufficient according to the terms of the smart contract, the process advances to step 1014. Otherwise, if the predicted valuation of the debt portfolio does not meet the terms of the smart contract, the execution bots may terminate the transfer of the debt portfolio. Any issues that are found with the debt portfolio, such as regulatory issues or valuation issues may be presented to the buyer and/or seller. The seller may have the opportunity to address and cure any issues that are flagged. The buyer may be given the opportunity to review the issues and decide whether they wish to proceed with the transaction. The terms of the transaction may be modified in view of the issues that are raised. If the terms are modified, a new smart contract may be generated corresponding to the new terms.

At step 1014, when the conditions (for example, compliance and sufficient predicted valuation) are met, the smart contract application 224 may update the smart contract accordingly. At step 1016, when the corporate users 212 engaged in the transaction agree with the terms and conditions of the smart contract, the smart contract application 224 may record the consent of the corporate users 212 to the terms and conditions in the smart contract and the store bots may store the smart contract in the distributed ledger 50.

At step 1020, the smart contract may be executed by the smart contract application 224. A payment associated with the debt portfolio is transferred from an account of one corporate user 212 (for example, the buyer) to an account of the second corporate user 212 (for example, the seller) using the payment application 232. Payment may be transferred from any other corporate users 212 involved in financing the transaction.

At step 1022, the store bots may save the data associated with the debt portfolio to the distributed ledger of the buyer. Finally, at step 1024, the debt portfolio management system 200 transfers an ownership of the debt portfolio to one of the corporate users 212 (for example, the buyer of the debt portfolio).

A notice of transfer of ownership may be automatically generated for each individual debt in the debt portfolio. The notice of transfer may be generated based on the regulations applicable to the individual loan. For each loan, a jurisdiction corresponding to the loan may be identified, such as a state. The regulations for that state may then be retrieved, and a notice that conforms with those regulations may be generated. The notice may be sent to the individual associated with the debt using contact information stored in the debt portfolio.

### Financing a Debt Portfolio Transfer

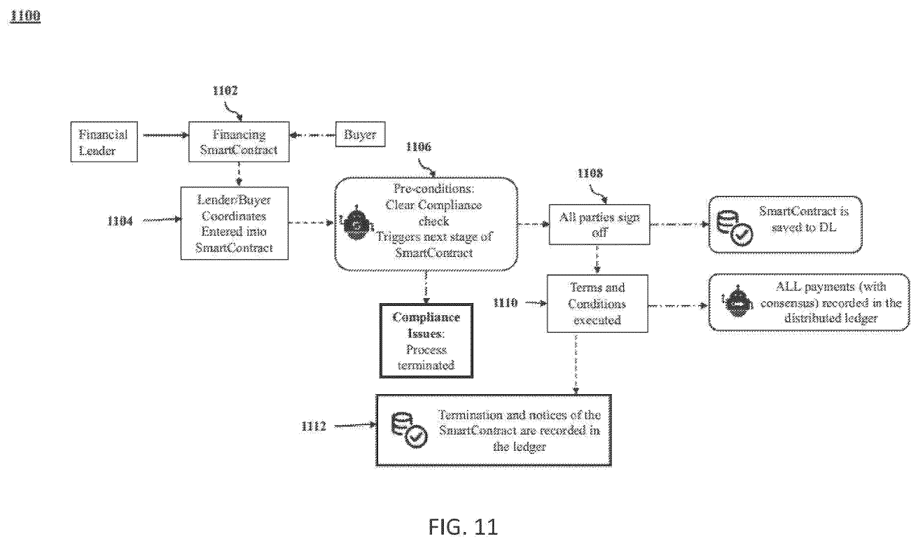

FIG. 11 illustrates a process 1100 of financing a debt portfolio, in accordance with various embodiments of the present disclosure. As shown, the process 1100 commences at step 1102, where at least two corporate users 212 (for example, a financial lender of the debt portfolio and a buyer of the debt portfolio) provide a request to the debt portfolio management system 200 for financing the debt portfolio. In certain embodiments, the request may be provided using the user device 20. The two corporate users 212 may enter their respective coordinates (for example, login credentials) on the portal/application/UI associated with the debt portfolio management system 200.

At step 1104, the fetch bots may verify the respective coordinates. Once the coordinates are verified, the fetch bots may populate the screen 190 of the device 20 with the dashboard and the application functions.

At step 1106, the fetch bots may verify that the corporate users 212 are compliant with the applicable regulations. In the event that a compliance issue is identified, the execution bots may terminate the financing process. In the event that the corporate users 212 are in compliance with the applicable regulations, the process advances to step 1108.

At step 1108, the smart contract application 224 may generate a smart contract for financing the debt portfolio. The smart contract may be generated based on a template for a financing smart contract. The smart contract application 224 may record the credentials of the corporate users 212 on the smart contract and the store bots may store the smart contract in the distributed ledger 50.

At step 1110, the smart contract is executed by the smart contract application 224. It is to be noted that the smart contract may be executed after the execution of a different smart contract that causes the transfer of the debt portfolio. During the execution of the smart contract, a payment associated with the debt portfolio is transferred from an account of one corporate user 212, for example a financial lender, to an account of another corporate user 212, for example a seller of the debt portfolio, using the payment application 232.

At step 1112, the store bots store the terminations and notices (for example, notice of financing) in the distributed ledger.

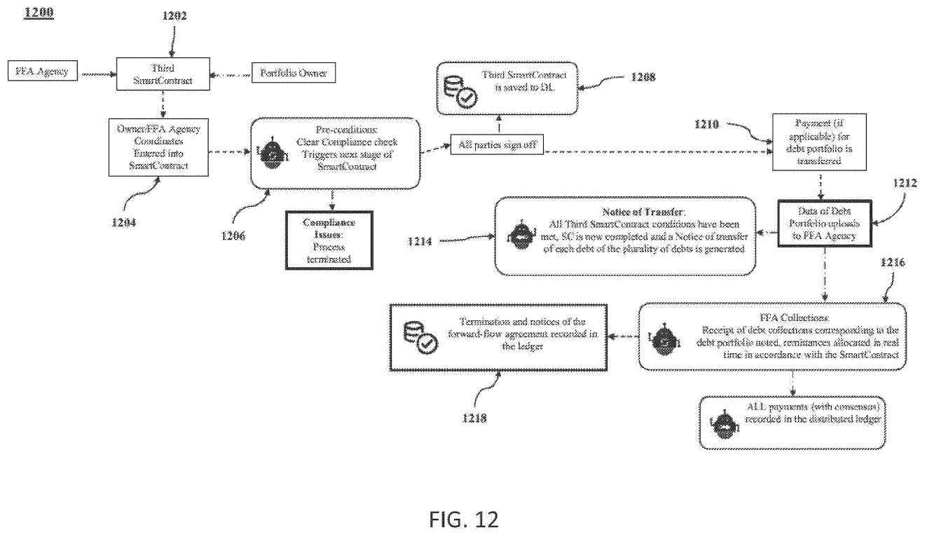

FIG. 12 illustrates a process 1200 of generating and recording a forward-flow agreement, in accordance with various embodiments of the present disclosure. As shown, the process 1200 commences at step 1202, where at least two corporate users 212, such as a forward-flow agreement agency and a debt portfolio owner, provide a request to the debt portfolio management system 200 to generate a forward-flow agreement. In certain embodiments, the request may be provided using the user device 20. The two corporate users 212 may enter their respective coordinates on the portal/application/UI associated with the debt portfolio management system 200.

At step 1204, the fetch bots may verify the respective coordinates. Once the coordinates are verified, the fetch bots may populate the screen 190 of the device 20 with the dashboard and the application functions. The coordinates of the involved parties may be recorded in the smart contract.

At step 1206, the fetch bots may verify that the corporate users 212 are compliant with the applicable regulations. In the event that a compliance issue is identified, the execution bots may terminate the financing process. In the event that the corporate users 212 are compliant with the applicable regulations, the process advances to step 1208.

At step 1208, the smart contract application 224 may generate a smart contract corresponding to the forward-flow agreement and save the smart contract to a distributed ledger. The smart contract may give access to at least a portion of the plurality of debts in the debt portfolio to a forward-flow agency. The forward-flow agency may be authorized to collect on the debts that they are given access to. A portion of the payments collected by the forward-flow agency may be remitted to the portfolio owner. The store bots may store the smart contract in the distributed ledger 50.

At step 1210 a payment associated with the portion of the plurality of debts in the debt portfolio is transferred from an account of one corporate user 212, such as the forward-flow agency, to an account of the other corporate user 212, such as the debt portfolio owner, using the payment application 232. In some instances, the smart contract may include a lump-sum payment for acquiring the rights to collect on the debts in the portfolio. In other instances, the smart contract may include a portion of the collections that are to be remitted to the debt portfolio seller. Or the forward-flow agreement may include some combination of lump sum payment and remittances based on collections.

At step 1212, the store bots may save the portion of debt portfolio for which the access is to be given to a permissioned distributed ledger associated with the forward-flow agency. This may provide the forward-flow agency with access to the data needed to begin collections on the debts that they have acquired the rights to.

At step 1214, once the conditions of the smart contract have been met, the execution bots generate a notice of the transfer of collections rights for each debt of the plurality of debts in the debt portfolio. The store bots may store the notices in the distributed ledger associated with the forward-flow agency. The notices may be generated automatically for each debt. The notices may be generated to be compliant with the regulations applicable to the debt. The notices may be automatically sent to the individuals associated with the debts.

At step 1216, the store bots record receipt of any debt collections corresponding to the debt portfolio in the distributed ledger 50. The remittances may be allocated automatically in accordance with the smart contract. Because the data related to payments is stored in the distributed ledger, the portfolio owner may be able to audit the transactions that have been performed and ensure that they receive the payments owed to them. The remittances to the portfolio owner may be performed automatically upon receiving any payments for the debts.

Finally, at step 1218, the store bots store any termination notices and notices of the forward-flow agreement in the distributed ledger 50.

### Operations-Managed Negotiation

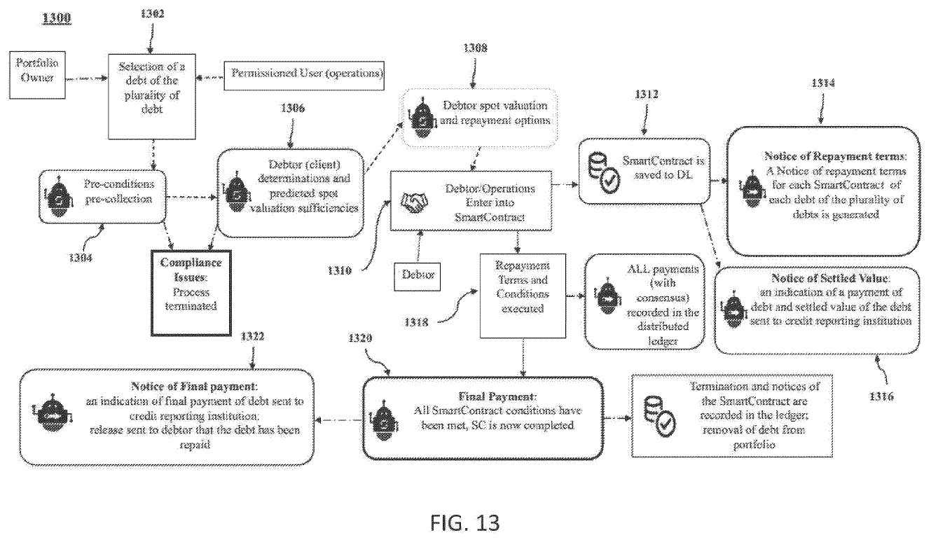

FIG. 13 illustrates a process 1300 for collecting on debts in a debt portfolio, in accordance with various embodiments of the present disclosure. As shown, the process 1300 commences at step 1302 where a corporate user 212, such as an owner of the debt portfolio or a permissioned user of the debt portfolio select a debt in the debt portfolio. The permissioned user may be an agent of the portfolio owner, such as a debt collections agent. In certain embodiments, the request may be provided using the user device 20. The corporate user 212 may enter their respective coordinates (for example, login credentials) on the portal/application/UI associated with the debt portfolio management system 200. The fetch bots may verify the respective coordinates. Once the coordinates are verified, the fetch bots may populate the screen 190 of the device 20 with the dashboard and the application functions. The corporate user 212 may then select the debt from the debt portfolio.

At step 1304, the fetch bots may verify that the corporate user 212 is compliant with the applicable regulations. In the event that a compliance issue is identified, the execution bots may terminate the process and prevent the corporate user 212 from proceeding with collecting on the debt until the compliance issue is resolved. In the event that the corporate user 212 is in compliance with the applicable regulations, the process advances to step 1306.

At step 1306, the fetch bots determine a client user associated with the debt. In other words, the debtor is identified. Additionally, the fetch bots may retrieve contact information and geographic information of the client user. Further, the fetch bots may retrieve, from the distributed ledger 50, previous debt repayment information corresponding to the client user. Based on the previous debt repayment, contact information and the geographic information, the debt portfolio management application 216 may generate a spot valuation of the debt. The spot valuation may be used to determine an option price expiry.

At step 1308, the debt portfolio management application 216 determines available repayment options based on the spot valuation. An acquisition cost of the debt and/or a carrying cost of the debt may be determined. A minimum repayment amount may be determined based on the acquisition cost of the debt and/or the carrying cost of the debt. The available repayment options may include repayment in full, flexible payments, negotiating the payment terms, and/or other repayment options.

After the debtor selects a repayment option a smart contract may be generated corresponding to the selected repayment option. At step 1310, the smart contract application 224 generates a smart contract between the corporate user 212 and the client user 238 (debtor). The smart contract includes the repayment option selected by the debtor. At step 1312, the fetch bots may store the smart contract in the distributed ledger 50.

At step 1314, the execution bots generate a notice of repayment terms of each debt of the plurality of debts and the store bots store the notice in the distributed ledger. The repayment terms may include various terms for the repayment of the debt by the client user 238, for example, method of payment, amount of each payment, frequency of the payments, and/or any other repayment term.

At step 1316, the execution bots generate a notice of settled value indicating an amount of the payment and a settled value of the debt and the store bots may store the notice in the distributed ledger. The debt portfolio management system 200 may forward the notice of settled value to a server associated with a credit reporting institution. The notice may provide the credit reporting institution with identifying information of the debtor, such as a social security number, the original amount of the debt, and/or the settled amount of the debt. The notice may be forwarded to the credit reporting institution automatically after the repayment terms are agreed to.

At step 1318, the execution bots execute the repayment terms and conditions. Each time a payment is received, the store bots may record an indication of the payment in the distributed ledger. The ledger may include a complete record of the payments made on a debt.

At step 1320, once the terms and conditions of the smart contract have been met, the smart contract may be considered to be completed. After completion of the smart contract, the execution bots may terminate the smart contract and may generate a termination/end of smart contract notice. The store bots may record the notice in the distributed ledger 50.

Finally, at step 1322, the execution bots generate a notice of final payment. The execution bots may send an indication that the debt has been paid in full, or at least a portion of the debt has been settled, to the server associated with the credit reporting institution. The notice to the credit reporting institution may be sent automatically after the final payment has been received. The execution bots may send a notification to the client user 238, via the client device 20, confirming that the debt has been settled and that no further payments on this debt are due.

### Client-Managed Negotiation

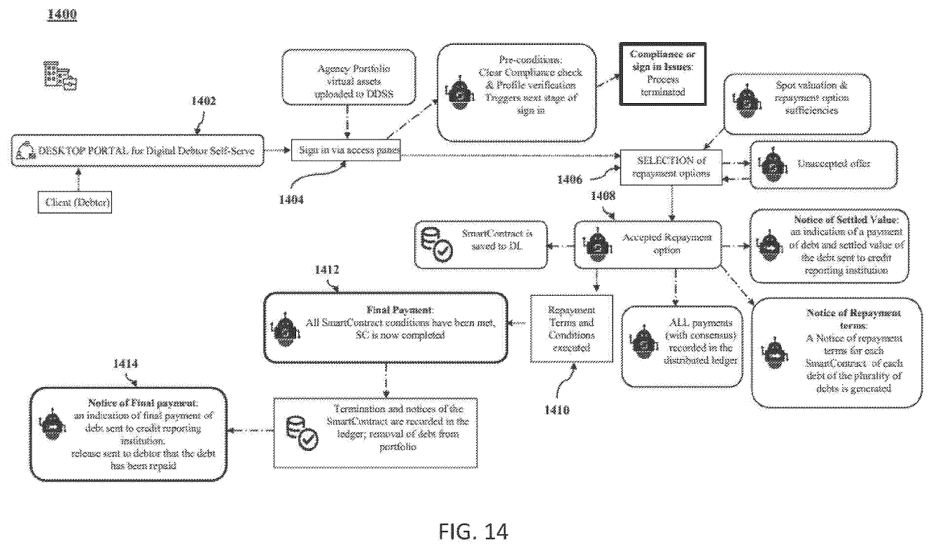

FIG. 14 illustrates a process 1400 for repayment of a debt using a collaborative Digital Debtor Self-Serve (DDSS) 222 interface, in accordance with various embodiments of the present disclosure. As shown, the process 1400 commences at step 1402, where the client user 238, i.e., a debtor, provides a request to the debt portfolio management system 200 for repayment of a debt. In certain embodiments, the request may be provided using the user device 20. The client user 238 may enter the respective coordinates (for example, login credentials) on the portal/application/UI associated with the debt portfolio management system 200. The DDSS interface may allow the debtor to select a repayment option, negotiate repayment terms, update contact information, authorize a payment, and/or perform other functions related to a debt without interacting with a human agent.

At step 1404, the fetch bots may verify the coordinates of the client user 238. Once the coordinates are verified, the fetch bots may populate the screen 190 of the device 20 with the dashboard and the application functions. Further, based on the request from the client user 238, the fetch bots may retrieve, from the distributed ledger 50, information corresponding to a debt associated with the client user 238 in a debt portfolio.

The information retrieved by the bots may include the name of the debtor, a geographical location corresponding to the debt, an amount of the debt, an amount that has already been repaid, and/or any other information corresponding to the debt. The bots may verify that the debt is compliant with the applicable regulations. In the event that an issue with compliance is identified, the debt portfolio management system 200 may terminate the repayment process for the debt. An administrator may be notified of the compliance issue to determine whether it can be resolved or if other steps should be taken, such as terminating the debt. In the event that the debt is in compliance with the applicable regulations, the debt portfolio management system 200 may trigger the next step of the repayment.

At step 1406, based on the information corresponding to the debt, the debt portfolio management application 216 and execution bots determine available repayment options for the debt. In certain embodiments, the execution bots may determine the available repayment options for the debt by using a MLA and generative AI. The MLA and generative AI may be used to determine a spot valuation of the debt. A minimum repayment amount may be determined based on an acquisition cost of the debt and/or a carrying cost of the debt. The repayment options may be determined based on the spot valuation and/or the minimum repayment amount.

The available repayment options may include paying in full, flexible payments, negotiation, and/or other repayment options. The client user 238 may select one of the repayment options via a user interface.

At step 1408, the fetch bots may store the selected repayment option in the distributed ledger 50. The smart contract application 234 may generate a smart contract based on the selected repayment option. The smart contract may be stored in the distributed ledger 50. Each time a payment is made by the debtor, a record of the payment may be stored in the distributed ledger 50.

The execution bots may generate a notice of a settled value of the debts. The notice may be automatically sent to a credit reporting institution.

At step 1410, the execution bots execute the repayment terms and conditions, and the store bots may record the payments received from the client user 238 associated with the debt in the distributed ledger 50.

At step 1412, once the terms and conditions of the smart contract have been met, such as when the final payment has been paid, the smart contract may be considered to be completed. On the completion of the smart contract, the execution bots may terminate the smart contract and may generate a termination/end of smart contract notice. The store bots may record the notice in the distributed ledger 50.

Finally, at step 1414, the execution bots generate a notice of final payment. The execution bots may send an indication of the debt has been paid in full to the server associated with a credit reporting institution. Additionally, the execution bots may send an indication to the client user 238, via the client device 20, that the debt has been paid in full. A release may be sent to the debtor indicating that the debt has been repaid.

### Evaluation of Portfolio for Sale, Write-Off, and Termination

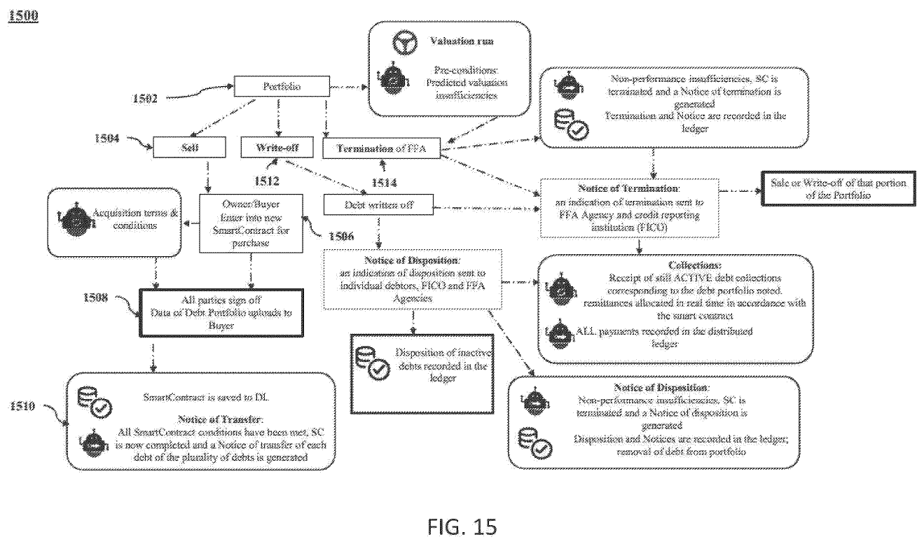

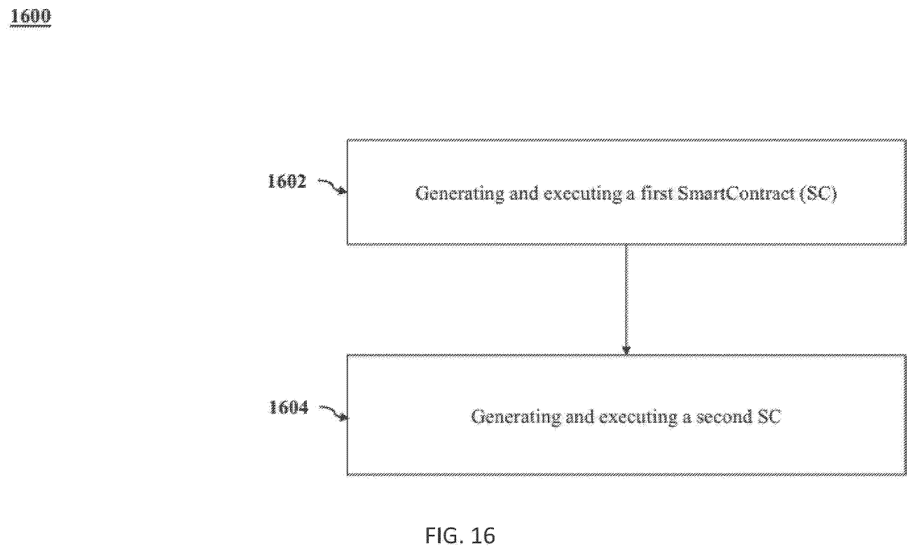

FIG. 15 illustrates a process 1500 for evaluation of the debt portfolio for sale, write-off, and/or termination, in accordance with various non-limiting embodiments of the present disclosure. As shown, the process commences at step 1502 where the debt portfolio is evaluated by the debt portfolio management application 216. The debt portfolio management application 216 may determine predicted valuation insufficiencies associated with at least a portion of the debt portfolio containing uncollectable debts. Based on the predicted valuation insufficiencies, the debt portfolio management application 216 may determine which debts in the debt portfolio are underperforming. The debt portfolio management application 216 may assist an operator in the process 1500 of determining whether the debt portfolio or at least a portion of the debt portfolio will be sold, written off, and/or if a forward-flow agreement will be terminated.

At step 1504, based on the determination that the debt portfolio or at least a portion of the debt portfolio is to be sold, the debt portfolio management system 200 may tag the debt portfolio or at least a portion of the debt portfolio as an “on sale” portfolio in the distributed ledger 50.

At step 1506, at least two corporate users 212 (for example, an owner of the debt portfolio and a buyer of the debt portfolio) may request, via the client devices 20, that the debt portfolio be transferred from the buyer to the seller. In certain embodiments, the fetch bots may verify that the corporate users 212 and the debt portfolio are compliant with the applicable regulations. The initial profiles and coordinates of the corporate users 212 may be verified. In the event that a compliance issue is identified, the debt portfolio management system 200 may terminate the sale of the debt portfolio. Otherwise, the debt portfolio management system 200 may trigger the smart contract application 224 to generate a smart contract between the two corporate users 212 defining the terms and conditions of the sale.

At step 1508, the parties may agree to the acquisition terms and conditions of the smart contract, and the smart contract application may record the consents of the corporate users 212 in the smart contract. The store bots may save data associated with the debt portfolio to the distributed ledger associated with the buyer.

At step 1510, the store bots save the smart contract in the distributed ledger 50. After the conditions of the smart contract have been fulfilled, the smart contract may be executed, and the debt portfolio may be transferred from the seller to the buyer. Notices of the transfer may be automatically generated and sent for each debt in the debt portfolio.

At step 1512, a selection may be received to write-off all or a portion of the debt portfolio. The execution bots may send an indication, such as a notice of termination or disposition, to a credit reporting institution server indicating that the debts have been written off.

At step 1514 a selection may be received to terminate a forward-flow agreement. A notice of termination may be sent for each debt to a credit reporting institution server. The termination of the forward-flow agreement may be recorded in the distributed ledger.

### Method Implemented on the Debt Portfolio Management System

FIG. 16 illustrates a process 1600 of a method for generating and executing smart contracts in accordance with various embodiments of the present disclosure. As shown, the process 1600 commences at step 1602, where the debt portfolio management system 200 generates and executes a first smart contract.

In certain embodiments, the debt portfolio management system 200 may generate a first smart contract corresponding to a debt portfolio comprising a plurality of debts. The debt portfolio management system 200 may store the first smart contract in the distributed ledger 50. The debt portfolio management system 200 may activate, based on self-executing functions of the first smart contract, a first bot, such as a fetch bot, to determine whether each debt in the debt portfolio and an owner of the debt portfolio, i.e., one of the corporate users 212, are compliant with regulations corresponding to the respective debt. The debt portfolio management system 200 may activate, based on the self-executing functions of the first smart contract, a second bot, such as an execution bot, to determine a predicted valuation for the debt portfolio. After confirming, by the first bot and the second bot, that the predicted valuation is sufficient for the first smart contract, and that the debt portfolio and owner are compliant with the regulations, the debt portfolio management system 200 may execute the first smart contract.

In certain embodiments, executing the first smart contract causes ownership of the debt portfolio to be transferred from the owner to one or more purchasers, and causes payment to be transferred to the owner.

In certain embodiments, the debt portfolio management system 200 may send a notice of transfer of ownership for each debt of the plurality of debts based on self-executing regulatory and compliance functions of the first smart contract.

In certain embodiments, the first smart contract may indicate one or more corporate user nodes purchasing the debt portfolio.

In certain embodiments, after determining that the plurality of debts have been repaid, the debt portfolio management system 200 may close the first smart contract.

In certain embodiments, the debt portfolio management system 200 may determine a write-off value of the debt portfolio containing the plurality of debts and may close the first smart contract, in the distributed ledger 50, corresponding to those debts.

The process 1600 may advance to step 1602 where the debt portfolio management system 200 generates and executes a second smart contract.

In certain embodiments, the debt portfolio management system 200 may generate a second smart contract corresponding to financing the purchase of the debt portfolio. The debt portfolio management system 200 may store the second smart contract in the distributed ledger 50. The debt portfolio management system 200 may execute the second smart contract after the first smart contract is executed. After receiving payments corresponding to the debt portfolio, the debt portfolio management system 200 may allocate the payments in accordance with the second smart contract.

In certain embodiments, the debt portfolio management system 200 may determine, by the first bot, whether a party to a forward-flow agreement (FFA) for the debt portfolio is compliant with the regulations corresponding to debt collection. The debt portfolio management system 200 may generate the second smart contract to give access to some or all of the debts in the debt portfolio according to an FFA. The debt portfolio management system 200 may store the second smart contract in the virtual ledger. The debt portfolio management system 200 may execute the second smart contract. The debt portfolio management system 200 may send a notice of transfer of collection rights for each debt of the plurality of debts based on self-executing regulatory and compliance functions of the first smart contract. After executing the second smart contract, the debt portfolio management system 200 may record receipt of any debt collections corresponding to the debt portfolio in the distributed ledger 50, may allocate remittances in accordance with the second smart contract, and may store any termination notices and notices of the forward-flow agreement in the virtual ledger.

In certain embodiments, the debt portfolio management system 200 may determine, by the first bot, whether an additional corporate user is compliant with regulations corresponding to the respective debt. The debt portfolio management system 200 may generate the second smart contract to indicate an additional corporate user node taking at least partial ownership of the debt portfolio. The debt portfolio management system 200 may execute the second smart contract, thereby transferring at least partial ownership of the debt portfolio to the additional corporate user node. After executing the second smart contract, the debt portfolio management system 200 may send a notice of transfer of ownership for each debt of the plurality of debts based on self-executing regulatory and compliance functions of the second smart contract, may record receipt of any debt collections corresponding to the debt portfolio in the virtual ledger, may allocate remittances in accordance with the second smart contract, and may store any termination notices and notices of syndication agreements in the distributed ledger 50.

In certain embodiments, executing the first or second smart contract causes debt repayment of at least one debt of the plurality of debts.

In certain embodiments, a new virtual network layer and a new virtual ledger are created with each new smart contract. Separate virtual network layers and separate virtual ledgers may be interconnected or linked due to the terms and conditions of a prior (initial) smart contract. For example and without limitation, purchase of an asset or debt portfolio may or may not include financing. Separate financing or syndication may require its own smart contract, resulting in the creating of its own virtual ledger and of its own virtual network layer, which may be linked to the original purchase of the asset for greater transparency involving collections cash flow. As another non-limiting example, the same may apply in the case of an asset or debt portfolio owner who may require additional help in collections, in forward flow agreements. As such, in onboarding an external agency through a new smart contract, distributed elements of a debt may remain linked with the owner's original debt portfolio. As in the above case, a new virtual ledger in a new virtual network layer is created. An initial smart contract may be stand-alone, or may be linked to n number of other smart contracts, for example in the case of the debt collector engaging in smart contracts with all those debtors included in the portfolio being worked. For each debtor, a new smart contract may be generated, a new virtual ledger of their outstanding debt and any payments/made on that account may be recorded, so that a plurality of transactions of this type are facilitated within their unique virtual network layer. This single debt may still be linked to the original debt portfolio, which is in the first smart contract's virtual ledger and virtual network layer. In this manner, the systems may retain transparency between the counterparties and executes/updates/records in real-time.

In certain embodiments, the debt portfolio management system 200 may output a first user interface comprising the plurality of debts, may give access to a permissioned user (for example, the corporate user) for a selection of a debt of the plurality of debts, may determine a geographical location corresponding to the debt, may retrieve regulatory restrictions corresponding to the geographical location and may output a second user interface comprising the regulatory restrictions and contact information corresponding to the debt.

In certain embodiments, the debt portfolio management system 200 may determine a debtor corresponding to the debt, may retrieve, from the distributed ledger 50, previous debt repayment information corresponding to the debtor (for example, the client user 238), may generate a spot valuation for the debt by inputting, to a MLA and generative AI, information corresponding to the debt and the previous debt repayment information, wherein the spot valuation comprises an option price expiry, and may store, in the virtual ledger, the spot valuation for the debt.

In certain embodiments, the debt portfolio management system 200 may determine available repayment options for the debt based on the spot valuation.

In certain embodiments, the debt portfolio management system 200 may determine a minimum repayment amount based on an acquisition cost of the debt and a carrying cost of the debt.

In certain embodiments, the debt portfolio management system 200 may determine a second valuation of the debt portfolio containing a plurality of debts, and generate, based on the second valuation of the debt portfolio, a second smart contract that transfers ownership of the debt portfolio to a second purchaser.

In certain embodiments, the debt portfolio management system 200 may retrieve, from the distributed ledger 50, information corresponding to a debt, wherein the information comprises a debtor (for example, the client user 238), a geographical location corresponding to the debt, and an amount of the debt. The debt portfolio management system 200 may determine, based on the information corresponding to the debt, available repayment options for the debt. The debt portfolio management system 200 retrieve regulatory restrictions corresponding to the geographical location. The debt portfolio management system 200 may generate, based on the debt, a UI accessible by the debtor associated with the debt, wherein the UI complies with the regulatory restrictions, and wherein the UI displays the available repayment options for the debt. The debt portfolio management system 200 may output, to the debtor, the UI. The debt portfolio management system 200 may receive user input indicating a selection of a repayment option of the available repayment options. The debt portfolio management system 200 may store, in the distributed ledger 50, the selected repayment option.

In certain embodiments, the available repayment options may comprise paying in full, flexible payments, or negotiation.

In certain embodiments, the debt portfolio management system 200 may determine the available repayment options for the debt by determining, by a MLA and generative AI, a spot valuation of the debt that is sufficient and compliant with the regulatory restrictions.

In certain embodiments, the debt portfolio management system 200 may determine the available repayment options for the debt by determining, by a MLA and generative AI, a minimum repayment amount based on an acquisition cost of the debt and a carrying cost of the debt.

In certain embodiments, storing a selected repayment option in the virtual ledger, comprises generating a smart contract corresponding to that confirmed repayment option, thereby causing payment to be transferred and storing the smart contract in the distributed ledger 50.

In certain embodiments, the debt portfolio management system 200 may send, to a server corresponding to a credit reporting institution, an indication of a payment of the whole or at least part of the settled value of the debt.

In certain embodiments, the debt portfolio management system 200 may receive an indication that a final payment has been made corresponding to the repayment option, may store, in the ledger, an indication that the debt has been repaid, may remove, from a debt portfolio, the debt, may send, to a server corresponding to a credit reporting institution, an indication that the debt has been repaid, and may send, to the debtor, a release that the debt has been repaid.

In certain embodiments, the debt portfolio management system 200 may determine a write-off value of the debt within a portfolio containing a plurality of debts, may close a smart contract, in the virtual ledger, corresponding to the debt, and may send, to the server corresponding to the credit reporting institution, an indication that the debt has been written off.

In certain embodiments, the debt portfolio management system 200 may output to a permissioned user (for example, the corporate user 212), an interface comprising a selection of debts from a debt portfolio including a plurality of debts. The debt portfolio management system 200 may retrieve, from the distributed ledger 50, information corresponding to the selection of debts, wherein the information comprises debtors, contact information of the debtors, geographical locations corresponding to the selection of debts, and the corresponding amounts of the selection of debts. The debt portfolio management system 200 may determine, based on the information corresponding to the selection of debts, available repayment options. The debt portfolio management system 200 may retrieve regulatory restrictions corresponding to the geographical locations.

In certain embodiments, the debt portfolio management system 200 may determine a debtor (for example, the client user 238) corresponding to a debt from the selection of debts. The debt portfolio management system 200 may retrieve, from the distributed ledger 50, previous debt repayment information corresponding to the debtor. The debt portfolio management system 200 may access a minimum repayment amount and available repayment options for the debt based on a ML-generated spot valuation, carrying and acquisition costs. The debt portfolio management system 200 may generate a smart contract with the debtor after confirming repayment options. The debt portfolio management system 200 may execute the smart contract, thereby causing payment to be transferred. The debt portfolio management system 200 may store the smart contract in the distribute ledger 50.

In certain embodiments, the debt portfolio management system 200 may send, to the server corresponding to the credit reporting institution, an indication of a payment of the whole or at least part of the settled value of the debt.

In certain embodiments, the debt portfolio management system 200 may receive an indication that a final payment has been made corresponding to the debt. The debt portfolio management system 200 may store, in the distributed ledger 50, the indication that the debt has been repaid. The debt portfolio management system 200 may remove, from the debt portfolio, the debt. The debt portfolio management system 200 may send, to the server corresponding to the credit reporting institution, the indication that the debt has been repaid and a settled value of the debt. The debt portfolio management system 200 may send, to the debtor corresponding to the debt, a release that the debt has been repaid.

In certain embodiments, the debt portfolio management system 200 may generate a spot valuation of a debt. To do so, the debt portfolio management system 200 may retrieve information corresponding to the debt from a smart contract stored in the distributed ledger 50. The debt portfolio management system 200 may retrieve, from the distributed ledger 50, previous debt repayment information for a debtor of the debt. The debt portfolio management system 200 may input, to an MLA and generative AI, the information corresponding to the debt and the previous debt repayment information, wherein the MLA and generative AI was trained using debt repayment information stored in the distributed ledger 50. The debt portfolio management system 200 may output, by the MLA and generative AI, the spot valuation of the debt.

In certain embodiments, the MLA and generative AI was trained to predict the spot valuation for a specific debt collecting organization.

In certain embodiments, the accuracy of the MLA's and generative AI predictions is improved by retrieving exogenous data and additional previous debt repayment information data from the distributed ledger.

In certain embodiments, the spot valuation of the debt comprises a range.

In certain embodiments, the debt portfolio management system 200 may retrieve, from the distributed ledger 50, information indicating historical debt collection results of the debt collecting organization, and wherein the MLA and generative AI was trained using the information indicating the historical debt collection results of the debt collecting organization.

In certain embodiments, any one the various functions, processes, methods, and systems described hereinabove may be employed for managing non-financial, tangible or intangible assets, such assets being included in obligation portfolios. In the description of these functions, processes, methods, and systems, all mentions of “debt” may be substituted with the terms “obligation”, “engagement”, or “pledge”, all mentions of “repayment” may be substituted with the term “compensation”, all mentions of “debtor” may be substituted with the term “beneficiary”, all mentions of “amount” may be substituted with the term “valuation”, as appropriate, when any one of the above-described embodiment relates to the management of non-financial assets in obligation portfolios.

While some of the above-described implementations may have been described and shown with reference to particular acts performed in a particular order, it will be understood that these acts may be combined, sub-divided, or re-ordered without departing from the teachings of the present disclosure. At least some of the acts may be executed in parallel or in series. Accordingly, the order and grouping of the act is not a limitation of the present disclosure.

It should be expressly understood that not all technical effects mentioned herein need be enjoyed in each and every embodiment of the present disclosure.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present disclosure may be apparent to those skilled in the art.

1. A method comprising:
generating a first smart contract corresponding to a debt portfolio comprising a plurality of debts, the first smart contract generating a virtual network layer and a virtual ledger;
storing the first smart contract in the virtual ledger on the virtual network layer;
activating, based on self-executing functions of the first smart contract, a first bot to determine whether each debt in the debt portfolio and an owner of the debt portfolio are compliant with regulations corresponding to the respective debt;
activating, based on the self-executing functions of the first smart contract, a second bot to determine a predicted valuation for the debt portfolio; and
after confirming, by the first bot, that the debt portfolio is compliant with the regulations, and confirming, by the second bot, that the predicted valuation is sufficient for the first smart contract, executing the first smart contract.

2. The method of claim 1, wherein executing the first smart contract causes ownership of the debt portfolio to be transferred from the owner to one or more purchasers, and causes payment to be transferred to the owner.

3. The method of claim 1, further comprising sending a notice of transfer of ownership for each debt of the plurality of debts based on self-executing regulatory and compliance functions of the first smart contract.

4. The method of claim 1, further comprising:
generating a second smart contract corresponding to financing a purchase of the debt portfolio, the second smart contract generating a new virtual network layer and a new virtual ledger;
storing the second smart contract in the new virtual ledger;
executing the second smart contract after the first smart contract is executed; and
after receiving payments corresponding to the debt portfolio, allocating the payments in accordance with the second smart contract.

5. The method of claim 1, further comprising:
determining, by the first bot, whether a buyer of a forward-flow agreement (FFA) for the debt portfolio is compliant with the regulations corresponding to debt collection;
generating a second smart contract corresponding to giving access to a portion or totality of a plurality of debts in a debt portfolio in the FFA, the second smart contract generating a new virtual network layer and a new virtual ledger;
storing the second smart contract in the new virtual ledger;
executing the second smart contract;
sending a notice of transfer of collection rights for each debt of the plurality of debts based on self-executing regulatory and compliance functions of the first smart contract; and
after executing the second smart contract:
recording receipt of any debt collections corresponding to the debt portfolio in the new virtual ledger,
allocating remittances in accordance with the second smart contract, and
storing any termination notices and notices of the forward-flow agreement in the new virtual ledger.

6. The method of claim 1, further comprising:
determining, by the first bot, whether an additional corporate user is compliant with regulations corresponding to the respective debt;
generating a second smart contract indicating an additional corporate user node taking at least partial ownership of the debt portfolio, the second smart contract generating a new virtual network layer and a new virtual ledger;
executing the second smart contract, thereby transferring at least partial ownership of the debt portfolio to the additional corporate user node; and
after executing the second smart contract:
sending a notice of transfer of ownership for each debt of the plurality of debts based on self-executing regulatory and compliance functions of the second smart contract,
recording receipt of any debt collections corresponding to the debt portfolio in the new virtual ledger,
allocating remittances in accordance with the second smart contract, and
storing any termination notices and notices of syndication agreements in the new virtual ledger.

7. The method of claim 4, wherein executing the first or second smart contract causes debt repayment of at least one debt of the plurality of debts.

8. The method of claim 7, further comprising:
outputting a first user interface displaying the plurality of debts;
giving access to the first user interface to a permissioned user for a selection of a debt of the plurality of debts;
determining a geographical location corresponding to the selected debt;
retrieving regulatory restrictions corresponding to the geographical location; and
outputting a second user interface displaying the regulatory restrictions and contact information corresponding to the selected debt.

9. The method of claim 8, further comprising:
determining a debtor corresponding to the selected debt;
retrieving, from the new virtual ledger, previous debt repayment information corresponding to the debtor;
generating a spot valuation for the selected debt by inputting, to an artificial intelligence (AI) algorithm, information corresponding to the selected debt and the previous debt repayment information, wherein the spot valuation comprises an option price expiry; and
storing, in the new virtual ledger, the spot valuation for the selected debt.

10. The method of claim 9, further comprising determining available repayment options for the selected debt based on the spot valuation.

11. The method of claim 10, further comprising determining a minimum repayment amount based on an acquisition cost of the selected debt and a carrying cost of the selected debt.

12. The method of claim 1, wherein the first smart contract indicates one or more corporate user nodes purchasing the debt portfolio.

13. The method of claim 1, further comprising closing the first smart contract after determining that the plurality of debts have been repaid.

14. The method of claim 1, further comprising:
determining a write-off value of at least a portion of the debt portfolio containing the plurality of debts, the portion containing uncollectable debts; and
closing the first smart contract in the virtual ledger corresponding to the uncollectable debts.

15. The method of claim 2, further comprising:
determining a second valuation of the debt portfolio containing a plurality of debts; and
generating, based on the second valuation of the debt portfolio, a second smart contract that transfers ownership of the debt portfolio to a second purchaser.

16. A method comprising:
retrieving, from a virtual ledger, information corresponding to a debt, the information comprising a debtor, a geographical location corresponding to the debt, and an amount of the debt;
determining, based on the information corresponding to the debt, available repayment options for the debt;
retrieving regulatory restrictions corresponding to the geographical location;
generating, based on the debt, a user interface accessible by the debtor associated with the debt, the user interface complying with the regulatory restrictions, and the user interface displaying the available repayment options for the debt;
outputting, to the debtor, the user interface;
receiving, via the user interface, user input indicating a selection of a repayment option of the available repayment options; and
storing, in the virtual ledger, the selected repayment option.

17. The method of claim 16, wherein the available repayment options comprise paying in full, flexible payments, or negotiation.

18. The method of claim 16, wherein determining the available repayment options for the debt comprises determining, by an artificial intelligence (AI) algorithm, a spot valuation of the debt that is sufficient and compliant with the regulatory restrictions.

19. The method of claim 16, wherein determining the available repayment options for the debt comprises determining, by an artificial intelligence (AI) algorithm, a minimum repayment amount based on an acquisition cost of the debt and a carrying cost of the debt.

20. The method of claim 16, wherein storing a selected repayment option in the virtual ledger comprises:
creating a smart contract generating a new virtual network layer and a new virtual ledger, the smart contract corresponding to the selected repayment option, thereby causing payment to be transferred; and
storing the smart contract in the new virtual ledger.

21.-46. (canceled)
